(19) United States
(12) Patent Application Publication
(10) Pub. No.: US 2025/0042174 A1
(43) Pub. Date: Feb. 6, 2025

(54) Recording Method And Recording Apparatus

(71) Applicant: SEIKO EPSON CORPORATION, Tokyo (JP)

(72) Inventor: Yuta ASAKAWA, Azumino (JP)

(21) Appl. No.: 18/788,242

(22) Filed: Jul. 30, 2024

(30) Foreign Application Priority Data
Jul. 31, 2023 (JP) 2023-124411

(51) Int. Cl. B41J 2/21; B41J 11/00; C09D 11/54

(52) U.S. Cl. CPC B41J 2/2117; B41J 11/0022; C09D 11/54

(57) ABSTRACT

A recording method according to an embodiment of the present disclosure includes a treatment liquid attachment step of ejecting a treatment liquid containing an aggregating agent from an ink jet head for a treatment liquid and attaching the treatment liquid to a recording medium, and an ink attachment step of ejecting an aqueous ink composition containing a coloring material from an ink jet head for ink and attaching the ink composition to the recording medium, in which the treatment liquid attachment step and the ink attachment step are performed by scanning performed while moving the ink jet head for a treatment liquid and the ink jet head for ink with respect to the recording medium, the treatment liquid and the ink composition are attached to a same scanning region in the same scanning, the aggregating agent is a calcium salt, a content of the calcium salt with respect to a total mass of the treatment liquid is 0.35 mol/kg or less, in the treatment liquid attachment step, a range of a maximum value of an attachment amount of the calcium salt in a region of the recording medium to which the treatment liquid and the ink composition are attached is 0.6 μmol/inch² or less, and in the treatment liquid attachment step and the ink attachment step, an air blowing step of blowing air onto the recording medium is provided.

The present application is based on, and claims priority from JP Application Serial Number 2023-124411, filed Jul. 31, 2023, the disclosure of which is hereby incorporated by reference herein in its entirety.

### BACKGROUND

### 1. Technical Field

The present disclosure relates to a recording method and a recording apparatus.

### 2. Related Art

Ink jet recording methods can record high-definition images with a relatively simple apparatus and are rapidly developed in various fields. Among these, a recording method in which by using a treatment liquid, the fluidity of ink is reduced and fixed at an early stage to obtain an excellent image quality is being studied. In particular, in a low-absorption or non-absorption recording medium, the ink droplets are less likely to be absorbed by the recording medium. Thus, the ink droplets may be mixed with each other on the recording medium to cause bleeding unevenness, and the use of a treatment liquid is being studied.

In addition, when a treatment liquid is used for recording in a serial type or lateral type printer, from the viewpoint of improving the recording speed and reducing the size of the apparatus, a recording method for simultaneous strike in which an ink jet head that ejects ink and an ink jet head that ejects the treatment liquid are arranged side by side in the scanning direction to attach the ink and the treatment liquid to the same scanning region in the same scanning is also being studied.

For example, JP-A-2020-032600 discloses a recording method for simultaneous strike in which ink and a treatment liquid are attached to the same scanning region in the same scanning.

However, in the recording method in which the ink and the treatment liquid are attached to the same scanning region in the same scanning, it is not yet sufficient to make all of the recovery from nozzle clogging, image quality, and whitening reduction of printed matter excellent.

### SUMMARY

According to an aspect of the present disclosure, there is provided a recording method including
a treatment liquid attachment step of ejecting a treatment liquid containing an aggregating agent from an ink jet head for a treatment liquid and attaching the treatment liquid to a recording medium, and
an ink attachment step of ejecting an aqueous ink composition containing a coloring material from an ink jet head for ink and attaching the ink composition to the recording medium, in which
the treatment liquid attachment step and the ink attachment step are performed by scanning performed while moving the ink jet head for a treatment liquid and the ink jet head for ink with respect to the recording medium,
the treatment liquid and the ink composition are attached to a same scanning region in the same scanning,
the aggregating agent is a calcium salt,
a content of the calcium salt with respect to a total mass of the treatment liquid is 0.35 mol/kg or less,
in the treatment liquid attachment step, a range of a maximum value of an attachment amount of the calcium salt in a region of the recording medium to which the treatment liquid and the ink composition are attached is 0.6 μmol/inch² or less, and
in the treatment liquid attachment step and the ink attachment step, an air blowing step of blowing air onto the recording medium is provided.

According to another aspect of the present disclosure, there is provided a recording apparatus that performs recording on the recording medium by the recording method according to the above aspect, the apparatus including the treatment liquid, the ink composition, the ink jet head for a treatment liquid, and the ink jet head for ink.

### BRIEF DESCRIPTION OF THE DRAWINGS

FIG. 1 is a schematic cross-sectional view schematically showing a serial type ink jet recording apparatus.

FIG. 2 is a perspective view showing an example of a configuration around a carriage of the serial type ink jet recording apparatus.

FIG. 3 is a schematic view showing an example of an arrangement of ink jet heads.

FIG. 4 is a schematic view showing an example of an arrangement of the ink jet heads.

FIG. 5 is a schematic view showing an example of an arrangement of the ink jet heads.

FIG. 6 is a front view schematically showing an example of a lateral type recording apparatus.

FIG. 7 is a bottom view partially showing a configuration of a recording unit of the lateral type recording apparatus.

FIG. 8 is a diagram (Table 1) showing composition examples of treatment liquids.

FIG. 9 is a diagram (Table 2) showing a composition example of an ink composition.

FIGS. 10A and 10B are diagrams (Table 3) showing examples of recording methods and evaluation results.

FIGS. 11A and 11B are diagrams (Table 4) showing examples of recording methods and evaluation results.

### DESCRIPTION OF EMBODIMENTS

Hereinafter, embodiments of the present disclosure will be described. The embodiments described below describe examples of the present disclosure. The present disclosure is not limited to the following embodiments, and includes various modifications implemented within a range not changing the gist of the present disclosure. It should be noted that not all of the configurations described below are essential configurations of the present disclosure.

In the present specification, a numerical range indicated by using “to” means a range including numerical values described before and after “to” as a lower limit value and an upper limit value.

### 1. Recording Method

According to an aspect of the present disclosure, there is provided a recording method including a treatment liquid attachment step of ejecting a treatment liquid containing an aggregating agent from an ink jet head for a treatment liquid and attaching the treatment liquid to a recording medium, and an ink attachment step of ejecting an aqueous ink composition containing a coloring material from an ink jet head for ink and attaching the ink composition to the recording medium, in which the treatment liquid attachment step and the ink attachment step are performed by scanning performed while moving the ink jet head for a treatment liquid and the ink jet head for ink with respect to the recording medium, the treatment liquid and the ink composition are attached to a same scanning region in the same scanning, the aggregating agent is a calcium salt, a content of the calcium salt with respect to a total mass of the treatment liquid is 0.35 mol/kg or less, in the treatment liquid attachment step, a range of a maximum value of an attachment amount of the calcium salt in a region of the recording medium to which the treatment liquid and the ink composition are attached is 0.6 μmol/inch² or less, and in the treatment liquid attachment step and the ink attachment step, an air blowing step of blowing air onto the recording medium is provided.

A recording method in which by using a treatment liquid, the fluidity of ink is reduced and fixed at an early stage to obtain an excellent image quality is being studied. In particular, in a low-absorption or non-absorption recording medium, the ink droplets are less likely to be absorbed by the recording medium. Thus, the ink droplets may be mixed with each other on the recording medium to cause bleeding unevenness, and the use of a treatment liquid is being studied.

In addition, when a treatment liquid is used in combination in a serial type or lateral type printer, there is a problem that a recording speed is reduced in a form in which the treatment liquid is first attached to a recording medium in advance and then ink is attached (treatment liquid first strike). In addition, in the above-described form, in a serial type printer, an ink jet head that ejects a treatment liquid can be arranged on an upstream in a direction (sub-scanning direction) intersecting a direction in which main scanning of the ink jet head is performed (main scanning direction), and an ink jet head that ejects ink can be arranged on a downstream. However, in this case, the overall length of the ink jet head in the sub-scanning direction becomes long, and the size of the apparatus is increased.

Therefore, from the viewpoint of improving the recording speed and reducing the size of the apparatus, a recording method for simultaneous strike in which an ink jet head that ejects ink and an ink jet head that ejects a treatment liquid are arranged side by side in the scanning direction and the ink and the treatment liquid are attached to the same scanning region in the same scanning is being studied.

However, in the simultaneous strike, the image quality is easily deteriorated as compared with the treatment liquid first strike. It is presumed that this is because there is an ink droplet that cannot come into contact with the treatment liquid droplet on the recording medium and does not cause an aggregation reaction. The deterioration of the image quality is that the ink droplets are gathered and mixed and the image quality is disturbed as described above. It is also called bleeding unevenness. Obtaining an excellent image quality means suppressing bleeding unevenness.

Therefore, by using polyvalent metal salts having excellent reactivity, particularly, a calcium salt having particularly excellent reactivity among the polyvalent metal salts, as an aggregating agent to be contained in the treatment liquid, an excellent image quality (bleeding unevenness suppression) can be obtained. It is presumed that this is because the fluidity of the ink droplets that come into contact with the treatment liquid droplets on the recording medium can be firmly stopped. However, when a polyvalent metal salt is used as an aggregating agent, depending on the concentration of the polyvalent metal salt contained, a crystallized substance may be formed in the vicinity of the surface of recorded matter, and a whitening phenomenon in which a white stain appears on the printed surface may occur.

On the other hand, in the simultaneous strike, there is a problem that the recovery from nozzle clogging is deteriorated. In the simultaneous strike, the mist of the treatment liquid easily flies to the nozzle that ejects the ink during the main scanning of the ink jet head, and when the ink and the mist of the treatment liquid react with each other to form foreign matter in the nozzle, it is difficult to recover the clogging even when cleaning is performed. When a calcium salt was used as an aggregating agent, the recovery from clogging is significantly deteriorated.

Therefore, when the concentration of the calcium salt in the treatment liquid is set to be equal to or less than a predetermined value, excellent recovery from clogging can be obtained. It is presumed that this is because the reactivity can be suppressed by making the concentration of the calcium salt in the treatment liquid relatively low, and the reaction between the ink and the treatment liquid and the formation of foreign matter in the nozzle can be reduced. However, in this case, since the reactivity of the treatment liquid is low, the quality of the recorded image (bleeding unevenness suppression) is deteriorated.

As described above, in the simultaneous strike, it is very difficult in the related art to make all of the recovery from nozzle clogging, the image quality (bleeding unevenness suppression), and the whitening reduction of the printed matter excellent.

Recently, it is found that by performing an air blowing step of blowing air onto an ink attachment region of a recording medium to promote drying in a step of attaching ink, in simultaneous strike, the recovery from nozzle clogging, the image quality (bleeding unevenness suppression), and the whitening reduction of the printed matter can be made excellent. The air blowing step promotes the evaporation of the moisture contained in the ink or the treatment liquid attached to the recording medium, and the concentration of the calcium ions can be increased. It is presumed that the reactivity tends to particularly increase as the concentration of the calcium ions increases, and even when the moisture evaporation is promoted by the air blowing step, an excellent image quality (bleeding unevenness reduction) can be obtained. In addition, since the concentration of the aggregating agent in the treatment liquid is low until the moisture is promoted to evaporate on the recording medium, the reaction between the ink and the treatment liquid and the formation of foreign matter in the nozzle can be reduced, and the recovery from clogging is also excellent.

Hereinafter, each step of the recording method according to the present embodiment will be described.

### 1.1 Treatment Liquid Attachment Step

The recording method according to the present embodiment includes a treatment liquid attachment step of ejecting a treatment liquid containing an aggregating agent from an ink jet head for a treatment liquid and attaching the treatment liquid to a recording medium.

### 1.1.1 Attachment Form

In the recording method according to the present embodiment, the treatment liquid attachment step and an ink attachment step described later are performed by scanning performed while moving the ink jet head for a treatment liquid and the ink jet head for ink with respect to the recording medium, and in the same scanning, the treatment liquid and an ink composition described later are attached to the same scanning region. In the treatment liquid attachment step, a range of a maximum value of an attachment amount of the calcium salt in a region of the recording medium to which the treatment liquid and the ink composition are attached is 0.6 μmol/inch² or less.

In the attachment form, for example, in a case in which a plurality of nozzle rows each formed of a plurality of nozzles that are arranged in a direction (hereinafter, also referred to as a “nozzle row direction”) intersecting a direction in which the ink jet head is moved (hereinafter, also referred to as a “head movement direction”) are provided on the nozzle surfaces of the ink jet head for a treatment liquid and the ink jet head for ink in the head movement direction, when the nozzle rows that eject the treatment liquid included in the ink jet head for a treatment liquid are projected in the head movement direction, the nozzle rows of the ink jet head for a treatment liquid can be arranged to at least partially overlap the nozzle rows that eject the ink included in the ink jet head for ink in the nozzle row direction (sequential strike), and it is preferable that the nozzle rows of the ink jet head for a treatment liquid are arranged so that all of the nozzle rows of the ink jet head for a treatment liquid overlap the all of the nozzle rows of the ink jet head for ink (completely simultaneous strike). Such an arrangement example of the ink jet heads will be described later.

In the treatment liquid attachment step, the range of the maximum value of the attachment amount of the calcium salt in the region in which the treatment liquid and the ink composition are attached to the recording medium is 0.6 μmol/inch² or less, preferably 0.5 μmol/inch² or less, more preferably 0.4 μmol/inch² or less, even more preferably 0.3 μmol/inch² or less, and particularly preferably 0.2 μmol/inch² or less. The lower limit is not particularly limited, and is preferably 0.05 μmol/inch² or more, and more preferably 0.1 μmol/inch² or more.

On the other hand, the range of the maximum value of the attachment amount of the calcium salt is 0.6 μmol/inch² or less, preferably 0.55 μmol/inch² or less, and more preferably 0.50 μmol/inch² or less. The lower limit is not particularly limited, and is preferably 0.1 μmol/inch² or more, more preferably 0.2 μmol/inch² or more, even more preferably 0.3 μmol/inch² or more, and particularly preferably 0.4 μmol/inch² or more.

When the range of the maximum value of the attachment amount of the calcium salt is 0.6 μmol/inch² or less, the whitening of the printed matter can be further reduced and a favorable rub resistance can be obtained. When the range of the maximum value of the attachment amount of the calcium salt is particularly 0.05 μmol/inch² or more, there is a tendency that an excellent image quality (bleeding unevenness) can be obtained. The attachment amount range described above may be the maximum attachment amount and may have an attachment amount region less than the maximum attachment amount on the recording medium. On the recording medium, a portion with a light color in the image may reduce the attachment amount of the calcium salt according to the attachment amount of the ink, or may have a constant attachment amount.

The attachment amount of the calcium salt [μmol/inch²] can be obtained by the product of the attachment amount [mg/inch²] of the treatment liquid and the calcium salt concentration [mol/kg]. In addition, the attachment amount of the calcium salt [μmol/inch²] is preferably an attachment amount of calcium ions [μmol/inch²]. That is, the number of moles of the calcium salt is preferably the number of moles of calcium included in the calcium salt.

The attachment amount of the treatment liquid per unit area of the recording medium is preferably 0.1 to 5 mg/inch², more preferably 0.1 to 4 mg/inch², even more preferably 0.1 to 3 mg/inch², particularly preferably 0.3 to 2.5 mg/inch², and more particularly preferably 0.3 to 2 mg/inch².

On the other hand, the attachment amount of the treatment liquid per unit area of the recording medium is preferably 1 to 10 mg/inch², more preferably 1 to 7 mg/inch², even more preferably 1 to 5 mg/inch², particularly preferably 1.5 to 4 mg/inch², and more particularly preferably 1.5 to 3.5 mg/inch².

When the attachment amount of the treatment liquid is large, the number of treatment liquid droplets ejected in 1 pass also increases, so that mist is more easily generated, and the recovery from clogging tends to be slightly inferior. However, it is found that the attachment amount of the calcium salt [μmol/inch²] has a particularly large influence on the recovery from clogging rather than the attachment amount of the treatment liquid [mg/inch²]. When the range of the attachment amount of the treatment liquid is within the above range, the recovery from nozzle clogging, image quality (bleeding unevenness), and the whitening reduction of printed matter tend to become further excellent. In addition, it is also preferable that the range of the maximum attachment amount of the treatment liquid is set to the above attachment amount range.

The maximum weight range per droplet of the liquid droplets of the treatment liquid is preferably 0.1 to 30 ng. Further, the maximum weight range is preferably 0.5 to 5 ng, more preferably 1 to 5 ng, even more preferably 2 to 4 ng, and particularly preferably 2.5 to 3.5 ng.

On the other hand, the maximum weight range per droplet of the liquid droplets of the treatment liquid is preferably 5 to 30 ng, more preferably 5 to 25 ng, even more preferably 7 to 20 ng, and particularly preferably 9 to 15 ng.

In this manner, the contact chance between the treatment liquid and the ink on the recording medium can be further increased, and as a result, there is a tendency that a further excellent image quality (bleeding unevenness) and a further excellent recovery from nozzle clogging can be obtained.

### 1.1.2 Recording Medium

In the recording method according to the present embodiment, in the treatment liquid attachment step and the ink attachment step described later, the surface temperature of the recording medium to which the attachment is applied is preferably 45° C. or lower. Further, the temperature is preferably 40° C. or lower, more preferably 35° C. or lower, even more preferably 30° C. or lower, and still even more preferably 25° C. or lower. In addition, it is particularly preferable that the temperature is room temperature without heating.

The lower limit of the surface temperature is not particularly limited, and is preferably 10° C. or higher, and more preferably 15° C. or higher. Further, the temperature is preferably 20° C. or higher. Furthermore, the temperature is preferably 30° C. or higher, more preferably 35° C. or higher, and even more preferably 38° C. or higher.

As a method for promoting the evaporation of the moisture of the ink or the treatment liquid attached to the recording medium, a method of heating the recording medium using warm air, a platen heater, or the like may be considered. However, in such a heating method, the ink in the vicinity of the nozzle is also dried by heat, and the recovery from clogging is easily particularly deteriorated. In addition, when the foreign matter formed in the vicinity of the nozzle is solidified by heating, particularly, the recovery from clogging is deteriorated. Therefore, when the surface temperature is equal to or lower than the above range, the recovery from clogging tends to be excellent, which is preferable. On the other hand, when the surface temperature is equal to or higher than the above range, the image quality tends to be further excellent, which is preferable.

The recording medium on which an image is formed by the recording method according to the present embodiment may have a recording surface which absorbs a liquid such as an ink composition or may not have a recording surface which absorbs a liquid. Therefore, the recording medium is not particularly limited, and examples thereof include liquid absorption recording media such as paper and fabric, liquid low-absorption recording media such as printed paper, liquid non-absorption recording media such as metal, glass, and film, and polymers, and the like. However, the excellent effect of the recording method according to the present embodiment is remarkable when an image is recorded on a low-absorption or non-absorption recording medium. That is, according to the recording method according to the present embodiment, an excellent image quality can be obtained even in a low-absorption recording medium or a non-absorption recording medium in which bleeding unevenness relatively easily occurs.

The liquid low-absorption or liquid non-absorption recording medium refers to a recording medium having a property of not absorbing a liquid at all or hardly absorbing a liquid. Quantitatively, a liquid non-absorption or liquid low-absorption recording medium means “a recording medium in which the amount of water absorbed from the start of contact to 30 msec^{1/2} by the Bristow method is 10 mL/m² or less”. The Bristow method is the most popular method for measuring the amount of liquid absorption in a short time and is also adopted by Japan Technical Association of the Pulp and Paper Industry (JAPAN TAPPI). The details of the test method are laid out in the standard No. 51 “JAPAN TAPPI Paper Pulp Test Method 2000 Edition” under “Paper and paperboard-Liquid absorbency test method-Bristow method”. On the other hand, the liquid absorption recording medium refers to a recording medium which does not correspond to liquid non-absorption or liquid low-absorption. In the present specification, liquid low-absorption or liquid non-absorption may be simply referred to as low-absorption and non-absorption.

Examples of the liquid non-absorption recording medium include films and plates of plastics such as polyvinyl chloride, polyethylene, polypropylene and polyethylene terephthalate (PET), plates of metals such as iron, silver, copper and aluminum, or metal plates manufactured by vapor deposition of these various metals, plastic films, and plates of alloys such as stainless steel, brass and the like. In addition, examples of the liquid non-absorption recording medium include a recording medium in which a base material such as paper is coated with plastics, a recording medium in which a plastic film is bonded to a base material such as paper, a plastic film which does not have an absorption layer (receiving layer), and the like. Examples of plastics here include polyvinyl chloride, polyethylene terephthalate, polycarbonate, polystyrene, polyurethane, polyethylene, polypropylene, and the like.

In addition, examples of the liquid low-absorption recording medium include a recording medium provided with a low-absorption coating layer on the surface thereof. Examples of a recording medium in which the base material is paper include printed paper such as art paper, coated paper, and cast coated paper, and in a case in which the base material is a plastic film, examples thereof include a recording medium in which a hydrophilic polymer or the like is applied onto the surface of polyvinyl chloride, polyethylene terephthalate, polycarbonate, polystyrene, polyurethane, polyethylene, polypropylene, or the like, and a recording medium on which particles such as silica and titanium are applied with a binder.

The liquid absorption recording medium is not particularly limited, and examples thereof include a plain paper, such as an electrophotographic paper having high liquid permeability, an ink jet printing paper (ink jet paper for exclusive use for ink jet provided with an ink absorption layer containing silica particles or alumina particles or an ink absorption layer containing a hydrophilic polymer, such as polyvinyl alcohol (PVA) or polyvinyl pyrrolidone (PVP)), and the like. Further, as the liquid absorption recording medium, a fabric, a nonwoven fabric, and the like can also be exemplified.

The recording medium may be colorless transparent, translucent, colored transparent, chromatic opaque, achromatic opaque, and the like. In addition, the recording medium itself may be colored or translucent or transparent.

Among the above-described examples, the recording medium is more preferably a low-absorption recording medium or a non-absorption recording medium. As a result, the effect exhibited by the present disclosure can be more effectively achieved. That is, in such a recording medium, since the ink composition is less likely to wet and spread in such a recording medium, bleeding unevenness particularly easily occurs. However, according to the recording method according to the present embodiment, even with such a recording medium, bleeding unevenness can be excellently reduced.

### 1.1.3 Treatment Liquid

Hereinafter, components contained in the treatment liquid used in the treatment liquid attachment step will be described. The treatment liquid is not an ink composition used for performing coloring on the recording medium, but an auxiliary liquid used together with the ink composition used for performing coloring. The treatment liquid may contain a coloring material such as a pigment or the like. The content of the coloring material is preferably 0.2% by mass or less, more preferably 0.1% by mass or less, and even more preferably 0.05% by mass or less with respect to a total mass of the treatment liquid, and the lower limit is 0% by mass. The treatment liquid preferably contains no coloring material.

### Aggregating Agent

The treatment liquid used in the recording method according to the present embodiment contains an aggregating agent which is a calcium salt, and a content of the calcium salt with respect to a total mass of the treatment liquid is 0.35 mol/kg or less.

The calcium salt has an effect of aggregating the coloring material and the resin particles by reacting with the components such as the coloring material contained in the ink, the resin particles contained in the ink, and the like. For example, such aggregation makes it possible to enhance the color development of the coloring material, to enhance the fixability of the resin particles, and/or to increase the viscosity of the ink.

Since an aggregating agent other than the calcium salt has a low reactivity compared with the calcium salt, a sufficient image quality cannot be obtained. In addition, when the cationic polymer is used as an aggregating agent, the recovery from clogging in the simultaneous strike is particularly deteriorated, and it is presumed that particularly coarse foreign matter is formed due to the reaction with the ink. In addition, in the aggregating agent other than the calcium salt, even when the concentration increases due to the evaporation of water by air blowing, the reactivity is less likely to be improved.

The calcium salt is a compound formed of calcium ions and anions. The anion constituting the calcium salt is an inorganic ion or an organic ion. Examples of the inorganic ion include a chloride ion, a bromine ion, an iodine ion, a nitrate ion, a sulfate ion, and a hydroxide ion. Examples of the organic ion include an organic acid ion, and examples thereof include a carboxylic acid ion, a formic acid ion, and the like.

Among these, the calcium salt is preferably a calcium salt of an organic acid. A calcium salt of an organic acid tend to have further excellent rub resistance compared with a calcium salt formed of an inorganic ion.

Specific examples of the calcium salt include calcium carbonate such as heavy calcium carbonate and light calcium carbonate, calcium nitrate, calcium chloride, calcium sulfate, calcium hydroxide, calcium formate (molecular weight: 130.1), calcium propionate (molecular weight: 186.2), calcium acetate, and calcium lactate. These calcium salts may be used alone or in combination of two or more thereof. These calcium salts may have hydration water in a raw material form. Examples thereof include calcium nitrate tetrahydrate (molecular weight: 236.2), calcium chloride dihydrate (molecular weight: 236.2), calcium acetate monohydrate (molecular weight: 176.2), and calcium lactate pentahydrate (molecular weight: 308.3).

The content of the calcium salt with respect to the total mass of the treatment liquid is 0.35 mol/kg or less, preferably 0.32 mol/kg or less, and more preferably 0.30 mol/kg or less. The lower limit is not particularly limited, and is preferably 0.01 mol/kg or more, more preferably 0.05 mol/kg or more, even more preferably 0.10 mol/kg or more, and particularly preferably 0.20 mol/kg or more.

In addition, the content of the calcium salt with respect to the total mass of the treatment liquid is preferably 10.0% by mass or less, more preferably 0.1% to 6% by mass, even more preferably 1.0% to 5% by mass, and particularly preferably 1.5% to 4% by mass.

### Water-Soluble Low-Molecular-Weight Organic Compound

The treatment liquid used in the recording method according to the present embodiment may contain a water-soluble low-molecular-weight organic compound. The water-soluble low-molecular-weight organic compound may be an organic solvent which is a liquid at room temperature alone, or may be a solid at room temperature alone. The water-soluble low-molecular-weight organic compound is preferably an organic solvent.

Here, in the water-soluble low-molecular-weight organic compound, the term “water-soluble” denotes that the solubility of the compound in 100 g of water at 20° C. is more than 10 g. A method for determining the solubility of the water-soluble low-molecular-weight organic compound is as follows. First, a predetermined amount of a compound is mixed into 100 g of water under an environment of 20° C., and the mixture is stirred for 30 minutes. When the compound is in a liquid state at room temperature, the compound is determined to be dissolved after the stirring in a case in which the compound does not have phase separation or a sea-island structure. Further, when the compound is in a solid state at room temperature, the compound is determined to be dissolved in a case in which undissolved residues are not found.

In this manner, when a predetermined amount of a compound is mixed into 100 g of water, the largest predetermined amount among the predetermined amounts of compounds determined to be dissolved is defined as the solubility. A low-molecular-weight organic compound having a solubility of more than 10 g is a water-soluble low-molecular-weight organic compound.

The water-soluble low-molecular-weight organic compound can be a compound completely miscible with water or a compound miscible with water.

In the present specification, the term “completely miscible with water” denotes that water and the organic compound mutually dissolve in each other, that is, the solubility of the organic compound in 100 g of water at 20° C. is infinite. In addition, the term “miscible with water” denotes that water and the organic compound have a finite solubility, which is at least a case in which the solubility of the organic compound in 100 g of water at 20° C. is more than 10 g.

The solubility of the water-soluble low-molecular-weight organic compound is more than 10 g, but the upper limit is not limited and may be infinite. The solubility is preferably 11 g or more, and more preferably 50 g or more.

In the water-soluble low-molecular-weight organic compound, the term “low-molecular-weight” denotes that the molecular weight is 500 or less. The molecular weight is preferably 400 or less, and more preferably 300 or less. The molecular weight is even more preferably 50 to 200.

The water-soluble low-molecular-weight organic compound preferably includes one having a normal boiling point of 150° C. to 350° C. The normal boiling point is more preferably 150° C. to 300° C. In addition, the water-soluble low-molecular-weight organic compound preferably includes a compound having a melting point of 90° C. or lower. Further, the water-soluble low-molecular-weight organic compound preferably includes a compound having a melting point of 80° C. or lower. In addition, the melting point is preferably −70° C. or higher.

Examples of the water-soluble low-molecular-weight organic compound include resin dissolving substances, polyols, glycol ethers, and alkanolamines. The resin dissolving substance is preferably selected from amides, sulfur-containing solvents, or cyclic ethers.

Among these, resin dissolving substances, polyols, and glycol ethers are preferable.

Resin dissolving substances that are any of amides, sulfur-containing solvents, and cyclic ethers, which have a normal boiling point of 150° C. to 300° C., and compounds of any of polyols and glycol ethers having a normal boiling point of 150° C. to 250° C. may be more preferable. Examples thereof further include other water-soluble low-molecular-weight organic compounds as necessary.

The water-soluble low-molecular-weight organic compound is preferably contained in an amount of 50% by mass or less with respect to the total mass of the treatment liquid. In addition, the amount of the water-soluble low-molecular-weight organic compound in the treatment liquid is preferably 1% by mass or more with respect to the total mass of the treatment liquid. In addition, the amount of the water-soluble low-molecular-weight organic compound is preferably 10% to 40% by mass, more preferably 15% to 35% by mass, and particularly preferably 20% to 30% by mass.

### Resin Dissolving Substance

Examples of the resin dissolving substance include amides, sulfur-containing solvents, and cyclic ethers. Among these, the resin dissolving substance is preferably any of amides, sulfur-containing solvents, or cyclic ethers, which have a normal boiling point of 150° C. to 300° C. Further, the resin dissolving substance is an organic compound having a function of dissolving a resin and improving the rub resistance, but the function is not limited thereto.

Examples of the amides cyclic amides (lactam) such as 2-pyrrolidone (2P), 2-piperidone, ε-caprolactam (CPL), N-methyl-ε-caprolactam, N-cyclohexyl-2-pyrrolidone, N-methylpyrrolidone, N-ethylpyrrolidone, N-butylpyrrolidone, 5-methyl-2-pyrrolidone, β-propiolactam, and ω-heptalactam, and chain-like amides such as N,N-dimethylacetoacetamide, N,N-diethylacetoacetamide, N-methylacetoacetamide, N,N-dimethyl isobutyric acid amide, N,N-dimethylformamide, N,N-diethylformamide, N,N-dimethylacetamide, N,N-diethylacetamide, N,N-dimethylpropionamide, 3-methoxy-N,N-dimethylpropanamide (DMPA), 3-n-butoxy-N,N-dimethylpropionamide, 3-methoxy-N,N-diethylpropionamide, 3-methoxy-N,N-methylethylpropionamide, 3-ethoxy-N,N-dimethylpropionamide, and 3-ethoxy-N,N-diethylpropionamide. Among these, any of 2-pyrrolidone (2P), ε-caprolactam (CPL), and 3-methoxy-N,N-dimethylpropylamide (DMPA) is more preferable, and there is a tendency that the storage stability of the treatment liquid can be made further excellent.

Examples of the sulfur-containing solvent include 3-methylsulfolane, sulfolane, ethyl isopropyl sulfone, ethyl methyl sulfone, dimethyl sulfone, dimethyl sulfoxide (DMSO), diethyl sulfoxide, tetramethylene sulfoxide, and methyl phenyl sulfoxide. Among these, dimethyl sulfoxide (DMSO) is more preferable and there is a tendency that the storage stability of the treatment liquid can be made further excellent.

Examples of the cyclic ethers include isosorbide dimethyl ether, 3-methyl-3-oxetanemethanol, 3-ethyl-3-oxetanemethanol (DMHD), 2-hydroxymethyloxetane, tetrahydrofurfuryl alcohol, solketal, glycerol formal, 1,4-dioxane-2,3-diol, and dihydrolevoglucosenone. Among these, 3-ethyl-3-oxetane methanol (DMHD) is more preferable and there is a tendency that the storage stability of the treatment liquid can be made further excellent.

### Polyols and Glycol Ethers

Examples of the water-soluble low-molecular-weight organic compound other than the resin dissolving substance include polyols and glycol ethers. Among these, any of polyols and glycol ethers having a normal boiling point of 150° C. to 250° C. is preferable.

### Polyols

The polyols are preferably glycols or compounds in which molecules of glycols are intermolecularly condensed between hydroxyl groups. In this case, the polyol is a compound having 2 hydroxyl groups.

Examples of the polyols include a compound in which a hydrogen atom of a glycol or a compound in which molecules of glycols are intermolecularly condensed between hydroxyl groups is replaced by a hydroxyl group. In this case, the polyol is a compound having at least 3 hydroxyl groups.

A glycol forming a polyol or a glycol unit in a compound in which molecules of glycols are intermolecularly condensed between hydroxyl groups has preferably 2 to 10 carbon atoms and more preferably 3 to 8. In addition, the polyols preferably have 2 to 15 carbon atoms, and more preferably have 3 to 10 carbon atoms. The polyols preferably have a normal boiling point of 150° C. to 250° C.

Examples of the polyols having a normal boiling point of 150° C. to 250° C. include ethylene glycol (normal boiling point: 198° C., miscible with water), diethylene glycol (normal boiling point: 244° C., completely miscible with water), 1,2-propanediol (propylene glycol: PG) (normal boiling point: 188° C., completely miscible with water), dipropylene glycol (normal boiling point: 227° C., completely miscible with water), 1,2-butanediol (normal boiling point: 193° C., miscible with water), 1,2-pentanediol (normal boiling point: 210° C., miscible with water), 1,2-hexanediol (1,2HD) (normal boiling point: 223° C., completely miscible with water), 1,3-propanediol (normal boiling point: 214° C., completely miscible with water), 1,4-butanediol (normal boiling point: 228° C., completely miscible with water), 2,3-butanediol (normal boiling point: 177° C., miscible with water), 1,3-butylene glycol (normal boiling point: 207° C., completely miscible with water), 3-methyl-1,3-butanediol (normal boiling point: 203° C., completely miscible with water), 2-methyl-1,3-propanediol (normal boiling point: 214° C., completely miscible with water), 2,2-dimethyl-1,3-propanediol (normal boiling point: 208° C., solubility: 83 [g/100 g of water]), 2-methylpentane-2,4-diol (normal boiling point: 197° C., completely miscible with water), 2,5-dimethyl-2,5-hexanediol (normal boiling point: 218° C., solubility: 14 [g/100 g of water]), 1,5-pentanediol (normal boiling point: 242° C., miscible with water), 3-methyl-1,5-pentanediol (normal boiling point: 250° C., completely miscible with water), and 1,6-hexanediol (normal boiling point: 250° C., miscible with water). As the polyols, polyols having 10 or less carbon atoms are more preferable.

Among the polyols, alkanediols having a normal boiling point of 150° C. to 250° C. and having 10 or less carbon atoms are more preferable, and alkanediols having a normal boiling point of 150° C. to 250° C. and having 6 carbon atoms or less are even more preferable. Examples of the alkanediols include 1,2-alkanediols, such as ethylene glycol, propylene glycol, 1,2-propanediol, 1,2-butanediol, 1,2-penetanediol, and 1,2-hexanediol, 1,3-propanediol, and 1,3-butylene glycol.

### Glycol Ethers

The glycol ethers are compounds in which one or more hydroxyl groups of glycol are etherified. Here, the glycol includes a compound in which two or more molecules of glycol are intermolecularly condensed between hydroxyl groups.

As the glycol ethers, alkylene glycol monoether or alkylene glycol diether is preferable. As the etherified ether, alkyl ether is preferable. The alkylene of alkylene glycol and the alkyl of alkyl ether constituting the glycol ethers each independently have preferably 1 to 5 carbon atoms and more preferably 2 to 4 carbon atoms. Glycol ethers having a normal boiling point of 150° C. to 250° C. are preferable.

Examples of the glycol ethers include alkylene glycol monoalkyl ethers such as ethylene glycol monomethyl ether (completely miscible with water), ethylene glycol monoethyl ether (miscible with water), ethylene glycol monoisopropyl ether (solubility: 100 [g/100 g of water]), ethylene glycol monopropyl ether (miscible with water), ethylene glycol monoisobutyl ether (solubility: 75.5 [g/100 g of water]), ethylene glycol mono-tert-butyl ether (miscible with water), ethylene glycol monobutyl ether (solubility: 100 [g/100 g of water]), diethylene glycol monomethyl ether (completely miscible with water), diethylene glycol monoethyl ether (completely miscible with water), diethylene glycol monoisopropyl ether (miscible with water), diethylene glycol monoisobutyl ether (completely miscible with water), diethylene glycol monobutyl ether (completely miscible with water), triethylene glycol monomethyl ether (completely miscible with water), triethylene glycol monoethyl ether (completely miscible with water), and triethylene glycol monobutyl ether (miscible with water).

In addition, diethers are more preferable to monoethers as the glycol ethers described above from the viewpoint that the resin tends to be easily dissolved or swollen in the ink and the rub resistance of an image to be formed tends to be improved. On the other hand, monoethers are preferable from the viewpoint that the storage spreadability of the treatment liquid is excellent.

The treatment liquid used in the recording method according to the present embodiment preferably contains any of polyols and glycol ethers as a water-soluble low-molecular-weight organic compound in an amount of 40% by mass or less, more preferably in an amount of 30% by mass or less, with respect to the total mass of the treatment liquid. In addition, as the lower limit value, the content is preferably 0% by mass or more and 10% by mass or more, and more preferably 15% by mass or more, with respect to the total mass of the ink composition.

In addition, it is more preferable that the content any of the polyols and the glycol ethers having a normal boiling point of 150° C. to 250° C. is set in the range described above, it is more preferable that the content of the alkanediols having a normal boiling point of 150° C. to 250° C. and having 10 or less carbon atoms is set in the range described above, and it is particularly preferable that the content of the alkanediols having a normal boiling point of 150° C. to 250° C. and having 6 or less carbon atoms is set in the range described above.

### Other Compounds

The treatment liquid used in the recording method according to the present embodiment may contain other water-soluble low-molecular-weight organic compounds as necessary.

### Alkanolamines

The treatment liquid may contain alkanolamines as a water-soluble low-molecular-weight organic compound. The alkanolamines are compounds having a hydroxyl group and an amino group in an alkane skeleton. The alkanolamines have 1 or more hydroxyl groups, preferably 1 to 5 hydroxyl groups, and more preferably 2 or 3 hydroxyl groups in a molecule. The alkanolamines have preferably 1 to 20 carbon atoms, more preferably 2 to 10 carbon atoms, and even more preferably 6 to 9 carbon atoms in a molecule. The alkane skeleton has preferably 1 to 6 carbon atoms and more preferably 2 to 4 carbon atoms per alkane skeleton. The alkanolamines have 1 or more amino groups, preferably 1 to 5 amino groups, and more preferably 1 or 2 amino groups in a molecule.

The alkanolamines are not particularly limited, and examples thereof include ethanolamine (miscible with water), N-methylethanolamine (solubility: 100 [g/100 g of water]), N,N-dimethylethanolamine (completely miscible with water), N-ethylethanolamine (miscible with water), N-butylethanolamine (miscible with water), N,N-diethylethanolamine (miscible with water), diethanolamine (solubility: 100 [g/100 g of water]), N-methyldiethanolamine (solubility: 100 [g/100 g of water]), N-ethyldiethanolamine (miscible with water), N-butyldiethanolamine (miscible with water), N-tert-butyldiethanolamine (completely miscible with water), triethanolamine (completely miscible with water), isopropanolamine (miscible with water), N,N-dimethylisopropanolamine (completely miscible with water), N,N-diethylisopropanolamine (miscible with water), diisopropanolamine (solubility: 87 [g/100 g of water]), triisopropanolamine (solubility: 83 [g/100 g of water]), diethanolamine (miscible with water), ethanol diisopropanolamine (miscible with water), N,N-dimethylpropanolamine (miscible with water), 2-amino-1-propanol (completely miscible with water), 2-amino-2-methyl-1-propanol (completely miscible with water), 5-amino-1-pentanol (miscible with water), 2-amino-2-methyl-1,3-propanediol (miscible with water), 2-amino-2-hydroxymethyl-1,3-propanediol (miscible with water), 3-amino-1,2-propanediol (miscible with water), 3-methylamino-1,2-propanediol (completely miscible with water), tripropanolamine, and tributanolamine. Among these, triethanolamine and triisopropanolamine are preferable, and triisopropanolamine is more preferable. The alkanolamines may be used alone or in combination of two or more thereof.

The content of the alkanolamines when the treatment liquid contains the alkanolamines is preferably 1% by mass or less, and more preferably 0.05% to 0.5% by mass with respect to the total mass of the treatment liquid. Polyols Having Normal Boiling Point of Higher Than 280° C.

The treatment liquid preferably does not contain more than 3% by mass of polyols having a normal boiling point of higher than 280° C. with respect to the total mass of the treatment liquid as the water-soluble low-molecular-weight organic compound. The content of the polyols having a normal boiling point of higher than 280° C. is more preferably not more than 1% by mass, and is even more preferably not more than 0.5% by mass. Further, it is preferable that the content is not more than 0.1% by mass.

In this case, the treatment liquid may or may not contain the polyols having a normal boiling point of higher than 280° C., and even when the treatment liquid contains the polyols having a normal boiling point of higher than 280° C., the content thereof is equal to or less than the above content. When the content of the polyols having a normal boiling point of higher than 280° C. is within the above range, the drying property of the treatment liquid can be prevented from being significantly lowered, and as a result, there is a tendency that the fixability of the image can be prevented from being lowered even when the recording is performed on a recording medium having low-absorption or non-absorption. In addition, even when the temperature of the recording medium when heating and drying is performed is set to a relatively low value, the recording medium tends to be sufficiently dried. Examples of such polyols having a normal boiling point of higher than 280° C. include glycerin (normal boiling point 290° C.), and alkanolamines such as triisopropanolamine are not included.

### Water

The treatment liquid used in the recording method according to the present embodiment may contain water, and is preferably an aqueous treatment liquid. The aqueous composition is a composition containing at least water as a main solvent component (liquid medium component) of the composition.

Examples of water include pure water such as ion exchange water, ultrafiltered water, reverse osmosis water, and distilled water, and water such as ultrapure water, from which ionic impurities are reduced. In addition, when water sterilized by irradiation with ultraviolet rays or addition of hydrogen peroxide or the like is used, the generation of bacteria or fungi can be suppressed when the treatment liquid is stored for a long period of time.

The water content is preferably 30% by mass or more, and more preferably 30% to 99% by mass in the liquid medium component. Further, the water content is preferably 30% to 95% by mass, more preferably 40% to 90% by mass, and even more preferably 50% to 80% by mass. Here, the liquid medium is a solvent component such as water or an organic solvent.

In addition, the water content is preferably 30% by mass or more, more preferably 40% by mass or more, even more preferably 45% by mass or more, and particularly preferably 50% by mass or more, with respect to the total mass of the treatment liquid. The upper limit of the water content is not particularly limited, and is, for example, preferably 99% by mass or less, more preferably 90% by mass or less, and even more preferably 80% by mass or less, with respect to the total mass of the treatment liquid.

### Surfactant

The treatment liquid used in the recording method according to the present embodiment may contain a surfactant. The surfactant has a function of adjusting the surface tension of the treatment liquid and adjusting, for example, the wettability with the recording medium. Among the surfactants, for example, an acetylene glycol-based surfactant, a silicone-based surfactant, and a fluorine-based surfactant can be preferably used, and a silicone-based surfactant is more preferable.

The acetylene glycol-based surfactant is not particularly limited, and examples thereof include SURFYNOL 104, 104E, 104H, 104A, 104BC, 104DPM, 104PA, 104PG-50, 104S, 420, 440, 465, 485, SE, SE-F, 504, 61, DF37, CT111, CT121, CT131, CT136, TG, GA, and DF110D (all trade names, manufactured by Air Products & Chemicals. Inc.), OLFINE B, Y, P, A, STG, SPC, E1004, E1010, PD-001, PD-002W, PD-003, PD-004, EXP. 4001, EXP. 4036, EXP. 4051, AF-103, AF-104, AK-02, SK-14, and AE-3 (all trade names, manufactured by Nissin Chemical Industry Co., Ltd.), and ACETYLENOL E00, E00P, E40, and E100 (all trade names, manufactured by Kawaken Fine Chemicals Co., Ltd.).

The silicone-based surfactant is not particularly limited, and examples thereof preferably include a polysiloxane-based compound. The polysiloxane-based compound is not particularly limited, and examples thereof include a polyether-modified organosiloxane. Examples of commercially available products of the polyether-modified organosiloxane include BYK-306, BYK-307, BYK-333, BYK-341, BYK-345, BYK-346, and BYK-348 (all trade names, manufactured by BYK Japan KK.), KF-351A, KF-352A, KF-353, KF-354L, KF-355A, KF-615A, KF-945, KF-640, KF-642, KF-643, KF-6020, X-22-4515, KF-6011, KF-6012, KF-6015, and KF-6017 (all trade names, manufactured by Shin-Etsu Chemical Co., Ltd.), and SILFACE SAG002, 005, 503A, 008 (all trade names, manufactured by Nissin Chemical Industry Co., Ltd.).

As the fluorine-based surfactant, a fluorine-modified polymer is preferably used, and specific examples thereof include BYK-3440 (manufactured by BYK Japan KK.), SURFLON 5-241, S-242, and S-243 (all trade names, manufactured by AGC SEIMI CHEMICAL CO., LTD.), and FTERGENT 215M (manufactured by NEOS COMPANY LIMITED).

When the treatment liquid contains a surfactant, a plurality of types of surfactants may be contained. The content when the treatment liquid contains the surfactant can be set to 0.1% by mass or more and 2% by mass or less, preferably 0.2% by mass or more and 1.5% by mass or less, and more preferably 0.3% by mass or more and 1.0% by mass or less, with respect to the total mass of the treatment liquid.

### Other Components

The treatment liquid used in the recording method according to the present embodiment may contain, in addition to the above-described components, components such as an additive, a resin dispersant, a preservative, a fungicide, a rust inhibitor, a chelating agent, a viscosity adjusting agent, an antioxidant, and the like, as long as the function is not impaired.

Examples of the additive include ureas, amines, and saccharides.

Examples of ureas include urea, ethyleneurea, tetramethylurea, thiourea, and 1,3-dimethyl-2-imidazolidinone, and betaines (such as trimethylglycine, triethylglycine, tripropylglycine, triisopropylglycine, N,N,N-trimethylalanine, N,N,N-triethylalanine, N,N,N-triisopropylalanine, N,N,N-trimethyl methyl alanine, carnitine, and acetyl carnitine).

Examples of the amines include diethanolamine, triethanolamine, and triisopropanolamine. The ureas or the amines may function as a pH adjuster.

Examples of the saccharides include glucose, mannose, fructose, ribose, xylose, arabinose, galactose, aldonic acid, glucitol (sorbitol), maltose, cellobiose, lactose, sucrose, trehalose, and maltotriose.

### 1.2 Ink Attachment Step

The recording method includes an ink attachment step of ejecting an aqueous ink composition containing a coloring material from an ink jet head for ink and attaching the ink composition to the recording medium.

### 1.2.1 Attachment Form

In the recording method according to the present embodiment, the treatment liquid attachment step and the ink attachment step described above are performed by scanning performed while moving the ink jet head for a treatment liquid and the ink jet head for ink with respect to the recording medium, and the treatment liquid and the ink composition are attached to the same scanning region in the same scanning. Such an attachment form can be achieved by the ink jet head arrangement described above or described later.

As a result, the treatment liquid and the ink composition are overlapped and attached in the same scanning region in the same scanning.

The attachment amount of the ink composition is preferably 0.5 to 40 mg/inch² per unit area of the recording medium.

Further, the attachment amount of the ink composition is preferably 0.5 to 20 mg/inch², more preferably 1 to 17 mg/inch², even more preferably 2 to 15 mg/inch², particularly preferably 3 to 12 mg/inch², and more particularly preferably 4 to 10 mg/inch².

On the other hand, the attachment amount of the ink composition is preferably 1 to 40 mg/inch², more preferably 2 to 34 mg/inch², even more preferably 4 to 30 mg/inch², particularly preferably 6 to 24 mg/inch², and more particularly preferably 8 to 20 mg/inch² per unit area of the recording medium.

The attachment amount of the ink composition may be in a range of the maximum attachment amount of the ink composition per unit area of the recording medium.

In the recording method according to the present embodiment, the number of times of scanning for attaching the ink composition to the same scanning region is preferably 10 or less, and more preferably 8 or less. In this case, the lower limit is preferably 2 or more, more preferably 4 or more, and even more preferably 6 or more.

On the other hand, the number of times of scanning for attaching the ink composition to the same scanning region is preferably 10 or less, more preferably 5 or less, even more preferably 3 or less, and particularly preferably 2 or less. Further, the number of times of scanning is preferably 1 or less. The number of times of scanning is 1 or more.

The smaller the number of times of scanning, the faster the recording speed, which is preferable. However, since the number of treatment liquid droplets per one scanning increases, the recovery from clogging is easily deteriorated. In addition, the number of ink droplets per one scanning also increases, and thus the ink droplets easily bleed and the image quality is easily deteriorated. In addition, the ink droplets are gathered and the filling of the ink covering the recording medium is easily deteriorated. As long as the number of times of scanning is within the above range, there is a tendency that the recovery from clogging and the image quality (bleeding unevenness) can be made excellent while maintaining a good recording speed.

The number of times of scanning refers to the number of times of scanning for an ink composition even when a plurality of ink compositions are used. In addition, in a case of the completely simultaneous strike, the number of times of scanning for attaching the ink composition to the same scanning region and the number of times of scanning for attaching the treatment liquid to the same scanning region are the same.

In addition, when recording is performed on any region, the number of passing times of the ink jet head on the region described above is also referred to as “pass” in some cases. For example, when the main scanning for attaching the ink is performed four times on the same region, the number of passes is referred to as 4 passes or the like.

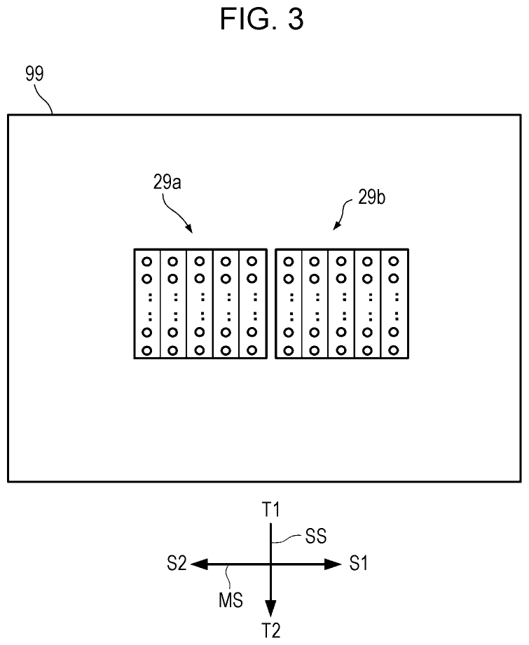

For example, in FIG. 3, when the length of one sub-scanning in a sub-scanning direction (SS direction) is one fourth of the length of a nozzle row in the sub-scanning direction (SS direction), four times of scanning are performed on a rectangular scanning region having a length of one sub-scanning in the sub-scanning direction (SS direction) and extending in the main scanning direction (MS direction). The number of passes is the number of times of scanning when viewed in this manner.

The scanning region is a rectangular region having a length of one sub-scanning in the sub-scanning direction and extending in the main scanning direction when the main scanning and the sub-scanning are alternately performed.

Alternatively, for example, in FIG. 3, the number of times of scanning can also be set to 4 by performing the main scanning for attaching the ink four times on the same region of the stopped recording medium without performing the sub-scanning. In this case, after four times of scanning are performed, sub-scanning may be performed.

The scanning region is a rectangular region having a length of the ink jet head in the sub-scanning direction and extending in the main scanning direction when one or more times of main scanning is performed without performing the sub-scanning on the recording medium whose position is fixed.

The number of times of scanning is also referred to as the number of scannings, the number of passes, or the like.

### 1.2.2. Ink Composition

Hereinafter, components contained in the ink composition used in the ink attachment step will be described. The ink composition is an aqueous composition containing a coloring material.

The ink composition may have the same composition as the treatment liquid except that the ink composition does not contain a calcium salt or an aggregating agent other than the calcium salt and contains a coloring material as an essential component.

### Coloring Material

The ink composition used in the recording method according to the present embodiment contains a coloring material. Examples of the coloring material include pigments and dyes.

### Pigment

As the pigment, for example, an inorganic pigment including carbon black and titanium white, an organic pigment, and the like can be used.

As the inorganic pigment, carbon black (C.I. Pigment Black 7) such as furnace black, lamp black, acetylene black, and channel black, iron oxide, titanium oxide, zinc oxide, silica, and the like can be used.

Examples of the carbon black include No. 2300, 900, MCF88, No. 20B, No. 33, No. 40, No. 45, No. 52, MA7, MA8, MA100, No. 2200B, and the like, manufactured by Mitsubishi Chemical Corporation. Examples include color black FW1, FW2, FW2V, FW18, FW200, S150, S160, S170, Pretex 35, U, V, 140U, special black 6, 5, 4A, 4, 250, and the like, manufactured by Degussa Corporation. Examples include Conductex SC, Raven 1255, 5750, 5250, 5000, 3500, 1255, 700, and the like, manufactured by Columbia Carbon Company. Examples include Regal 400R, 330R, and 660R, Mogul L, Monarch 700, 800, 880, 900, 1000, 1100, 1300, and 1400, Elftex 12, and the like, manufactured by Cabot Corporation.

Examples of the organic pigment include a quinacridone-based pigment, a quinacridone quinone-based pigment, a dioxazine-based pigment, a phthalocyanine-based pigment, an anthrapyrimidine-based pigment, an anthanthrone-based pigment, an indanthrone-based pigment, a flavanthrone-based pigment, a perylene-based pigment, a diketopyrrolopyrrole-based pigment, a perinone-based pigment, a quinophthalone-based pigment, an anthraquinone-based pigment, a thioindigo-based pigment, a benzoimidazolone-based pigment, an isoindolinone-based pigment, an azomethine-based pigment, an azo-based pigment, or the like.

Specific examples of the organic pigment used in the ink composition include the following.

Examples of the cyan pigment include C. I. Pigment Blue 1, 2, 3, 15:3, 15:4, 15:34, 16, 22, 60, and the like; C. I. Vat Blue 4, 60; and the like, and are preferably one or a mixture of two or more selected from the group consisting of C. I. Pigment Blue 15:3, 15:4, and 60.

Examples of magenta pigments include C.I. Pigment Red 5, 7, 12, 48 (Ca), 48 (Mn), 57 (Ca), 57:1, 112, 122, 123, 168, 184, 202, and C.I. Pigment Violet 19, preferably C.I. Pigment Red 122, 202, and 209, preferably one or a mixture of two or more selected from the group consisting of C.I. Pigment Violet 19. A solid solution of the pigment may be used.

Examples of the yellow pigment include C.I. Pigment Yellow 1, 2, 3, 12, 13, 14C, 16, 17, 73, 74, 75, 83, 93, 95, 97, 98, 119, 110, 114, 128, 129, 138, 150, 151, 154, 155, 180, 185, and the like, and preferably include one or a mixture of two or more selected from the group consisting of C.I. Pigment Yellow 74, 109, 110, 128, 138, 155, and 180.

Examples of the orange pigment include C. I. Pigment Orange 36 or 43 or a mixture thereof. Examples of the green pigment include C.I. Pigment Green 7 or 36 or a mixture thereof.

In addition, a bright pigment may be used, and the pigment is not particularly limited as long as the pigment can exhibit brightness when attached to a medium. Examples thereof include metal particles of one or alloys of two or more (also referred to as metal pigment) selected from the group consisting of aluminum, silver, gold, platinum, nickel, chromium, tin, zinc, indium, titanium, and copper, a pearl pigment having pearl gloss, and the like. Representative examples of the pearl pigment include pigments having pearl gloss and interference gloss such as titanium dioxide coated mica, fish scale foil, and bismuth oxychloride. In addition, the bright pigment may be subjected to a surface treatment for suppressing a reaction with water.

In addition, a white pigment may be used, and examples thereof include metal compounds such as metal oxide, barium sulfate, and calcium carbonate. Examples of the metal oxide include titanium dioxide, zinc oxide, silica, alumina, and magnesium oxide. In addition, particles having a hollow structure may be used for the white pigment.

The above-mentioned pigments may be used alone or in combination of two or more thereof. The pigment is preferably an organic pigment from the viewpoint of storage stability such as light resistance, weather resistance, and gas resistance.

For the volume average particle diameter (D50) of the pigment, a volume average particle diameter (D50) when measured by a dynamic light scattering method is 20 nm or more and 300 nm or less, the volume average particle diameter (D50) is more preferably 30 nm or more and 200 nm or less, and the volume average particle diameter (D50) is even more preferably 40 nm or more and 100 nm or less.

The measurement of the volume average particle diameter may be performed by using, for example, a Nanotrac series particle diameter distribution measurement device manufactured by MicrotracBEL Corp. In addition, examples of a method for adjusting the volume average particle diameter include a method for adjusting the degree of pulverization of the pigment before dispersion, a method for adjusting the volume average particle diameter by adjusting the stirring conditions (for example, the stirring speed, the stirring temperature, and the like) during dispersion, and a method for adjusting the volume average particle diameter by filtration using a filter after dispersion.

The pigment may be used by being dispersed using a pigment dispersant. Further, the pigment may be used by being dispersed as a self-dispersing pigment by oxidizing or sulfonating a pigment surface with ozone, hypochlorous acid, fuming sulfuric acid, and the like.

The pigment dispersant has a function of dispersing the pigment in the ink composition. The pigment dispersant may be water-soluble. However, the pigment dispersant is preferably not completely water-soluble, and it is considered that the pigment dispersant is partially or entirely bonded to or adsorbed on the pigment to enhance the hydrophilicity of the surface of the pigment to disperse the pigment. The pigment dispersant is preferably a polymer compound, and more preferably a resin. The pigment dispersed by a pigment dispersant, which is a resin, is also referred to as a resin-dispersed pigment.

Examples of the resin of the pigment dispersant include acrylic resin such as poly(meth)acrylic acid, (meth)acrylic acid-acrylonitrile copolymer, (meth)acrylic acid-(meth)acrylic acid ester copolymer, vinyl acetate-(meth)acrylic acid ester copolymer, vinyl acetate-(meth)acrylic acid copolymer, vinylnaphthalene-(meth)acrylic acid copolymer, styrene-(meth)acrylic acid copolymer, styrene-(meth)acrylic acid copolymer, styrene-(meth)acrylic acid-(meth)acrylic acid ester copolymer, styrene-α-methylstyrene-(meth)acrylic acid copolymer, and styrene-α-methylstyrene-(meth)acrylic acid-(meth)acrylic acid ester copolymer, and salts thereof. In the present specification, a polymer having a skeleton derived from (meth)acrylic acid and not having a skeleton derived from maleic acid or similar compounds is referred to as an acrylic resin. In the present specification, the term “(meth)acrylic acid” means acrylic acid or methacrylic acid.

In addition, examples of the resin of the pigment dispersant include resins such as maleic acid-based resin such as styrene-maleic acid copolymer, styrene-maleic anhydride copolymer, vinylnaphthalene-maleic acid copolymer, and vinyl acetate-maleic acid ester copolymer and salts thereof; urethane-based resin with or without a cross-linked structure and salts thereof; polyvinyl alcohols; and vinyl acetate-crotonic acid copolymer and salts thereof.

The acrylic resin may be a copolymer of an acrylic monomer and another monomer, in addition to the polymer of the acrylic monomer as mentioned above. For example, an acrylic vinyl resin which is a copolymer with a vinyl-based monomer as another monomer is also referred to as an acrylic resin. In addition, for example, among the above-mentioned styrene-based resins, those which are copolymers of a styrene-based monomer and an acrylic monomer are also included in the acrylic resin. In addition, when referring to the acrylic resin, the salt and the esterified product thereof are also included.

Examples of commercially available products of the pigment dispersant include X-200, X-1, X-205, X-220, and X-228 (manufactured by Seiko PMC Corporation), Nopcospars (registered trademark) 6100 and 6110 (manufactured by San Nopco Ltd.), Joncryl 67, 586, 611, 678, 680, 682, and 819 (manufactured by BASF Japan Ltd.), DISPERBYK-190 (manufactured by BYK Japan KK), N-EA137, N-EA157, N-EA167, N-EA177, N-EA197D, N-EA207D, and E-EN10 (manufactured by DKS Co., Ltd.), and the like.

Examples of commercially available products of the acrylic pigment dispersants include BYK-187, BYK-190, BYK-191, BYK-194N, and BYK-199 (manufactured by BYK Japan KK.), and Aron A-210, A6114, AS-1100, AS-1800, A-30SL, A-7250, and CL-2 (manufactured by TOAGOSEI CO., LTD.).

Examples of commercially available products of the urethane-based pigment dispersant include BYK-182, BYK-183, BYK-184, and BYK-185 (manufactured by BYK Japan KK.), TEGO Dispers 710 (manufactured by Evonik Tego Chemi GmbH), and Borchi (registered trademark) Gen 1350 (manufactured by OMG Borchers GmbH).

The pigment dispersant may be used alone, or may be used in combination of two or more thereof. The total content of the pigment dispersant is 0.1% by mass or more and 30% by mass or less, preferably 5% by mass or more and 25% by mass or less, and more preferably 10% by mass or more and 20% by mass or less with respect to 100% by mass of the ink. By setting the content of the pigment dispersant to 0.1% by mass or more, the dispersion stability of the pigment can be ensured. In addition, when the content of the pigment dispersant is 30% by mass or less, the viscosity of the ink composition can be suppressed to be small.

In addition, a weight average molecular weight of the pigment dispersant is more preferably 500 or more. By using such a pigment dispersant, the odor is reduced and the dispersion stability of the pigment can be made more favorable.

When the pigment is dispersed by the pigment dispersant, a ratio of the pigment to the pigment dispersant is preferably 10:1 to 1:10, and more preferably 4:1 to 1:3.

The self-dispersing pigment is, for example, a pigment in which one or more functional groups selected from the group consisting of a carbonyl group, a carboxyl group, an aldehyde group, a hydroxyl group, a sulfone group, an ammonium group, and salts thereof are directly or indirectly bonded to the surface thereof to modify the surface.

Examples of the self-dispersion pigment include organic pigments such as carbon black, azo lake, insoluble azo pigments, condensed azo pigments, chelate azo pigments, phthalocyanine pigments, perylene pigments, perinone pigments, quinacridone pigments, thioindigo pigments, isoindolinone pigments, quinophthalone pigments, dioxazine pigments, anthraquinone pigments, nitro pigments, nitroso pigments, and aniline black, and inorganic pigments such as titanium white, zinc white, lead white, carbon blacks, red iron oxide, vermilion, cadmium red, chrome yellow, ultramarine blue, cobalt blue, cobalt violet, and zinc chromate.

Among these, the self-dispersing pigment is preferably carbon black from the viewpoint of being able to print black at a high concentration and having further excellent ejection reliability.

As the self-dispersion pigment, a preparation prepared by a known method or a commercially available product can be used. Examples of commercially available products include “MICROJET CW1” and “MICROJET CW2” manufactured by Orient Chemical Industries, Ltd., “CAB-O-JET 200” and “CAB-O-JET 300” manufactured by Cabot Corporation, and the like.

### Dye

In the ink composition, a dye may be used as a coloring material. Although the dye is not particularly limited, acid dyes, direct dyes, reactive dyes, basic dyes, and dispersion dye can be used.

The above-mentioned dyes may be used alone or in combination of two or more thereof.

Among these, the coloring material is preferably any of a resin-dispersed pigment, a self-dispersion pigment, and a dye. Since such a coloring material can be preferably dispersed in the aqueous ink, the color developing property and the ejection stability tend to be further improved.

The lower limit of the content of the coloring material is not particularly limited, and is preferably 0.1% by mass or more, more preferably 0.5% by mass or more, even more preferably 1.0% by mass or more, and still even more preferably 1.5% by mass or more, with respect to the total amount of the ink composition. When the content of the coloring material is within the above range, the color developing property tends to be excellent.

The upper limit of the content of the coloring material is not particularly limited, and is preferably 20% by mass or less, more preferably 15% by mass or less, even more preferably 10% by mass or less, still even more preferably 78 by mass or less, and particularly preferably 5% by mass or less, with respect to the total amount of the ink composition. When the content of the coloring material is within the above range, the ejection stability tends to be excellent.

### Water

The ink composition used in the recording method according to the present embodiment is an aqueous ink composition. The term “aqueous” refers that at least water is contained as a solvent component, and water may be included as a main solvent component. The type and content of water are the same as those of the above-described treatment liquid, and description will be made by replacing “treatment liquid” with “ink composition”.

### Water-Soluble Low-Molecular-Weight Organic Compound

The ink composition used in the recording method according to the present embodiment may contain a water-soluble low-molecular-weight organic compound. The type and content of the water-soluble low-molecular-weight organic compound are the same as those of the treatment liquid described above, and description will be made by replacing “treatment liquid” with “ink composition”.

The water-soluble low-molecular-weight organic compound is preferably contained in an amount of 40% by mass or less with respect to the ink composition of the treatment liquid. In addition, the amount of the water-soluble low-molecular-weight organic compound in the treatment liquid is preferably 1% by mass or more with respect to the total mass of the treatment liquid. In addition, the amount of the water-soluble low-molecular-weight organic compound is preferably 5% to 30% by mass, more preferably 5% to 25% by mass, and particularly preferably 10% to 25% by mass.

### Surfactant

The ink composition used in the recording method according to the present embodiment may contain a surfactant. The type and content of the surfactant are the same as those of the treatment liquid described above, and description will be made by replacing “treatment liquid” with “ink composition”.

### Resin Particles

The ink composition used in the recording method according to the present embodiment may contain resin particles. The resin particles can further improve the adhesion of an image due to the ink composition attached to the recording medium. Examples of the resin particles include resin particles formed of urethane-based resins, acrylic resins (including styrene-acrylic resin), fluorene-based resins, polyolefin-based resins, rosin-modified resins, terpene-based resins, polyester-based resins, polyamide-based resins, epoxy-based resins, vinyl chloride-based resins, vinyl chloride-vinyl acetate copolymers, and ethylene vinyl acetate-based resins. Among these, a urethane-based resin, an acrylic resin, a polyolefin-based resin, and a polyester-based resin are preferable. These resin particles are often handled in the form of an emulsion, but may be in the form of powder. In addition, the resin particles can be used alone or in combination of two or more thereof.

Urethane-based resin is a generic term for resins having a urethane bond. For the urethane-based resin, a polyether-type urethane resin including an ether bond in the main chain, a polyester-type urethane resin including an ester bond in the main chain, a polycarbonate-type urethane resin including a carbonate bond in the main chain, and the like, in addition to a urethane bond, may be used. In addition, as the urethane-based resin, commercially available products may be used, for example, the urethane-based resin selected from the commercially available products such as Superflex 460, 460s, 840, E-4000 (trade name, manufactured by DKS Co., Ltd.), Resamine D-1060, D-2020, D-4080, D-4200, D-6300, D-6455 (trade name, manufactured by Dainichiseika Color & Chemicals MFG Co., Ltd.), Takelac WS-6021, W-512-A-6 (trade name, manufactured by Mitsui Chemicals Polyurethane Co., Ltd.), Sancure 2710 (trade name, manufactured by LUBRIZOL), Permarin UA-150 (trade name, manufactured by Sanyo Chemical Industries Ltd.), and the like may be used.

Acrylic resin is a generic term for polymers obtained by polymerizing at least acrylic monomers such as (meth)acrylic acid and (meth)acrylic acid ester as one component, and examples thereof include a resin obtained from an acrylic monomer and a copolymer of an acrylic monomer and other monomers. Examples thereof include an acrylic-vinyl-based resin which is a copolymer of an acrylic monomer and a vinyl-based monomer, and the like. In addition, examples of the vinyl-based monomer include styrene and the like.

As the acrylic monomer, acrylamide, acrylonitrile, and the like can also be used. For the resin emulsion using acrylic resin as a raw material, a commercially available product may be used, and for example, any resin emulsion may be selected and used from FK-854 (trade name, manufactured by CHIRIKA Co., Ltd.), Mowinyl 952B, and 718A (trade names, manufactured by Japan Coating Resin Corporation), Nipol LX852 and LX874 (trade names, manufactured by Zeon Corporation), and the like.

Incidentally, in the present specification, the acrylic resin may be a styrene-acrylic resin described below. In addition, in the present specification, the notation of “(meth)acrylic” means acrylic and methacrylic.

The styrene-acrylic resin is a copolymer obtained from a styrene monomer and a (meth)acrylic monomer, and examples thereof include styrene-acrylic acid copolymers, styrene-methacrylic acid copolymers, styrene-methacrylic acid-acrylate copolymers, styrene-α-methylstyrene-acrylic acid copolymers, and styrene-α-methylstyrene-acrylic acid-acrylate copolymers. As the styrene acrylic resin, a commercially available product may be used, and for example, Joncryl 62J, 7100, 390, 711, 511, 7001, 631, 632, 741, 450, 840, 74J, HRC-1645J, 734, 852, 7600, 775, 537J, 1535, PDX-7630A, 352J, 352D, PDX-7145, 538J, 7640, 7641, 631, 790, 780, and 7610 (trade names, manufactured by BASF SE), Mowinyl 966A and 975N (trade names, manufactured by Japan Coating Resin Corporation), VINYBLAN 2586 (manufactured by Nissin Chemical Industry Co., Ltd.), and the like may be used.

The polyolefin-based resin has an olefin such as ethylene, propylene, or butylene in the structural skeleton, and known ones can be appropriately selected and used. As the olefin resin, a commercially available product can be used, for example, ARROWBASE CB-1200, CD-1200 (trade name, manufactured by Unitika Ltd.), and the like may be used.

The glass transition temperature (Tg) of the resin particles is preferably −50° C. or higher and 200° C. or lower, more preferably 0° C. or higher and 150° C. or lower, and even more preferably 50° C. or higher and 100° C. or lower. Further, the glass transition temperature is particularly preferably 50° C. or higher and 80° C. or lower. When the glass transition temperature (Tg) of the resin particles is within the above range, the resin particles tend to be excellent in durability and clogging resistance. The glass transition temperature is measured, for example, using a differential scanning calorimeter “DSC7000”, manufactured by Hitachi High-Tech Science Corporation, in accordance with JIS K 7121 (Testing Methods for Transition Temperatures of Plastics).

The volume average particle diameter of the resin particles is preferably 10 nm or more and 300 nm or less, more preferably 30 nm or more and 300 nm or less, even more preferably 30 nm or more and 250 nm or less, and particularly preferably 40 nm or more and 220 nm or less. The volume average particle diameter can be measured by the method described above.

The acid value of the resin of the resin particles is preferably 50 mg KOH/g or less, more preferably 30 mg KOH/g or less, even more preferably 20 mg KOH/g or less, and still even more preferably 10 mg KOH/g or less. Further, the lower limit of the acid value is 0 mg KOH/g or more, preferably 5 mg KOH/g or more, and more preferably 10 mg KOH/g or more. This case is preferable since the image quality and the like are excellent. The acid value can be measured by the method described above.

The content when the ink composition contains the resin particles is 0.1% by mass or more and 10% by mass or less, preferably 0.5% by mass or more and 5% by mass or less, and more preferably 1% by mass or more and 5% by mass or less, as a solid content with respect to the total mass of the ink composition.

### Other Components

The ink composition used in the recording method according to the present embodiment may contain other components. The other components are the same as those of the treatment liquid described above, and description will be made by replacing “treatment liquid” with “ink composition”.

### 1.3 Air Blowing Step

The recording method according to the present embodiment includes, in the treatment liquid attachment step and the ink attachment step described above, an air blowing step of blowing air onto the recording medium is provided.

In the treatment liquid attachment step and the ink attachment step, the air blowing step of blowing air onto the recording medium is provided. In the air blowing step, an air blowing step may be performed on a portion of the recording medium supported by a recording medium support portion such as a platen while performing the treatment liquid attachment step and the ink attachment step, and the air blowing step may be performed in the vicinity of the portion of the recording medium supported by the recording medium support portion.

The air blowing step is performed on the recording medium on the platen at a position facing the ink jet head. In the air blowing step, air may be blown onto the recording medium at a position where the treatment liquid attachment step and the ink attachment step are performed, so that the treatment liquid and the ink attached to the recording medium are dried. Further, air blowing may be blown such that the solvent component of the treatment liquid or the ink evaporated from the recording medium is removed by blowing air to promote the evaporation.

For example, the air may be blown not only near the surface of the recording medium but also at a position away from the surface of the recording medium.

The air blowing step may be performed at the same time as, before, or after the treatment liquid and the ink composition are attached to the recording medium, and is preferably performed after the attachment.

In the air blowing step, the wind speed is preferably 0.5 m/s or higher. Further, the wind speed is preferably 1.0 m/s or higher, more preferably 1.5 m/s or higher, even more preferably 2.0 m/s or higher, and still even more preferably 2.5 m/s or higher. When the wind speed of the air blowing is within the above range, the drying property tends to be further improved and the image quality (bleeding unevenness) tends to be further improved. In addition, the vapor of the ink component may be diffused, and the condensation on the nozzle surface may be reduced. The upper limit of the wind speed is not particularly limited, and is preferably 20 m/s or lower, more preferably 15 m/s or lower, even more preferably 10 m/s or lower, and particularly preferably 5 m/s or lower.

The wind speed is the maximum wind speed measured within the range of the height of the carriage on which the ink jet head is mounted from the surface of the recording medium within the range of the recording medium positioned at the position supported by the platen.

The wind temperature of the air blowing in the air blowing step is preferably 80° C. or lower. Further, the wind temperature is preferably 45° C. or lower, more preferably 40° C. or lower, even more preferably 35° C. or lower, still even more preferably 30° C. or lower, and yet still even more preferably 25° C. or lower. The wind is preferably not heated, and is particularly preferably wind at room temperature. The lower limit of the wind temperature is not particularly limited, and is preferably 10° C. or higher, and more preferably 15° C. or higher. In addition, the lower limit is preferably 20° C. or higher.

The air blowing in the air blowing step is preferably room temperature air, but may be warm air. The wind temperature of the warm air is preferably 80° C. or lower, more preferably 80° C. to 35° C., and even more preferably 60° C. to 35° C. The wind temperature is measured at a position where the wind speed is measured in a state of not being affected by heat excluding the temperature of the wind itself.

The air blowing step may be performed using a blower mechanism configured to blow air in the vicinity of the recording surface side of the recording medium supported by the platen. For example, a fan or the like can be used.

### 1.4 Secondary Drying Step

The recording method according to the present embodiment may further include a secondary drying step of heating the recording medium after the treatment liquid attachment step and the ink attachment step described above. The secondary drying step can be performed, for example, by using an appropriate heating unit. The secondary drying step is performed by, for example, an after-heater (in the example of the serial type ink jet recording apparatus described later, a heating heater 59 corresponds to the after-heater), and it is preferable that the heating is performed after the recording medium passes through the platen. In addition, the heating unit is not limited to the heating unit included in the ink jet recording apparatus, and other drying units may be used. With this, the obtained image can be dried and more sufficiently fixed, and thus, for example, the recorded matter can be brought in a state of being usable at an early stage.

The surface temperature of the recording medium reaching by heating in the secondary drying step is preferably 50° C. or higher. The surface temperature is 60.0° C. or higher and 120.0° C. or lower, preferably 70.0° C. or higher and 100.0° C. or lower, more preferably 70.0° C. or higher and 90° C. or lower, and even more preferably 70° C. or higher and 80° C. or lower. The surface temperature of the recording medium reaching by heating in the secondary drying step is particularly preferably 70° C. or higher. When the surface temperature of the recording medium is within this range, there is a tendency that the resin particles can be formed into a film and flattened, and the obtained image can be dried and more sufficiently fixed.

### 1.5 Other Steps

The recording method according to the present embodiment may include a primary drying step. The primary drying step includes the above-mentioned air blowing step, but may also include a primary drying step other than the air blowing step.

The primary drying step is a step of drying the recording medium in the treatment liquid attachment step and ink attachment step described above.

The primary drying step other than the air blowing step can be performed by a unit that stops recording and leaves the recording medium to stand, or by a unit that performs drying using a drying mechanism. Examples of the unit that performs drying using a drying mechanism include a unit that irradiates the recording medium with radiation (such as infrared rays) which generates heat, (radiation type), a member that comes into contact with the recording medium and conducts heat to the recording medium (conduction type), and a combination of two or more of these units.

In the primary drying step, a case where the drying mechanism that heats the recording medium is used as the drying mechanism is particularly referred to as the primary heating step. For example, among the above-mentioned drying mechanisms, conduction type and the radiation type are applicable.

Even when the primary drying step is performed, the surface temperature of the recording medium to which the attachment is applied as described above is preferably 35° C. or lower.

In addition, the treatment liquid attachment step and ink attachment step described above may not be accompanied by the primary heating step. That is, it is preferable that in the recording method of the present embodiment, the recording medium is not heated by the heating mechanism for heating the recording medium provided in the member supporting the recording medium, and the recording medium is not heated by the heating mechanism for heating the recording medium from above at the location where the ink composition and the treatment liquid are attached. In such a case, the surface temperature of the recording medium in the treatment liquid attachment step and the ink attachment step is likely to be a low temperature equal to or lower than a predetermined temperature, and the recovery from clogging tends to be excellent.

### 1.6 Continuous Printing Time

The recording method according to the present embodiment is preferably performed by continuous recording performed for 0.5 hours or longer, more preferably by continuous recording performed for 1 hour or longer, even more preferably by continuous recording performed for 1.5 hours or longer, and still even more preferably by continuous recording performed for 2 hours or longer. The upper limit is not particularly limited, and is preferably 10 hours or shorter continuously, more preferably 7 hours or shorter continuously, and particularly preferably 5 hours or shorter continuously.

When the continuous recording time is long, the recovery from clogging tends to be deteriorated. However, in the recording method according to the present embodiment, there is a tendency that favorable recovery from clogging can be obtained even with the above continuous recording time, which is preferable.

The continuous printing time is a time for repeatedly performing scanning and transport of the recording medium (sub-scanning or the like) and continuously recording a plurality of images. During continuous printing, maintenance that requires a long time, such as sucking the ink from the ink jet head, is not performed. The maintenance that can be completed in a short time, such as flushing, may be performed.

### 2. Recording Apparatus

A recording apparatus according to an embodiment of the present disclosure is a recording apparatus that performs recording on the recording medium by the above-described recording method, and includes the treatment liquid, the ink composition, the ink jet head for a treatment liquid, and the ink jet head for ink.

According to the recording apparatus according to the present embodiment, recording is performed by the above-described recording method, and thus the recovery from nozzle clogging, the image quality (bleeding unevenness), and the whitening reduction of the printed matter are excellent.

The treatment liquid and the ink composition included in the recording apparatus according to the present embodiment are as described above, and thus the description thereof will be omitted. Hereinafter, an example of the recording apparatus according to the present embodiment will be described with reference to the drawings.

### 2.1 Serial Type Recording Apparatus

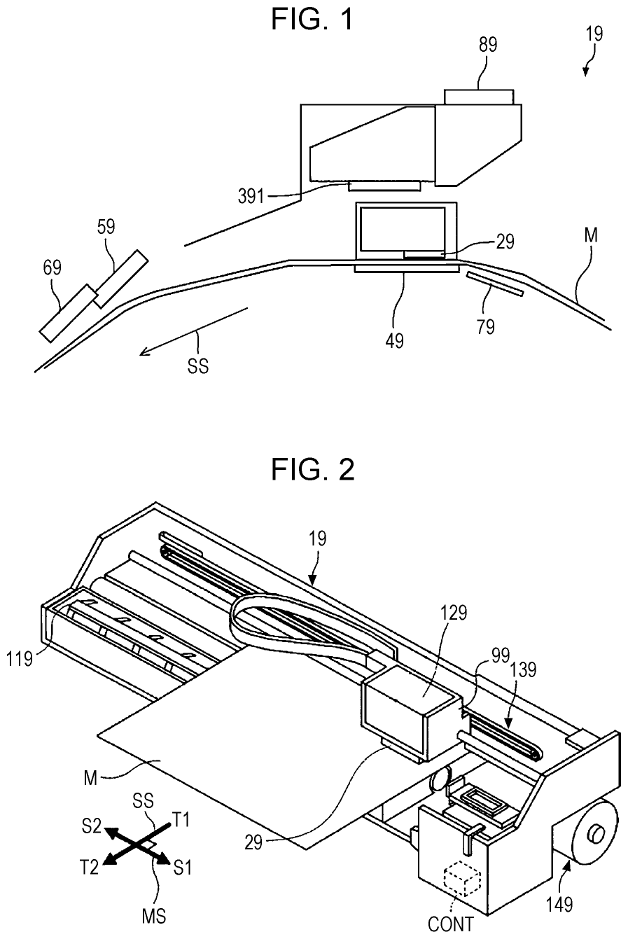

FIG. 1 is a schematic cross-sectional view schematically showing a serial type ink jet recording apparatus 19. FIG. 2 is a perspective view showing an example of a configuration around a carriage of the ink jet recording apparatus 19 in FIG. 1. As shown in FIGS. 1 and 2, the ink jet recording apparatus 19 includes an ink jet head 29, an IR heater 391, a platen heater 49, a heating heater 59, a cooling fan 69, a preheater 79, a ventilation fan 89, a carriage 99, a platen 119, a carriage moving mechanism 139, a transport unit 149, and a controller CONT. In the ink jet recording apparatus 19, the operation of the entire ink jet recording apparatus 19 is controlled by the controller CONT shown in FIG. 2.

The ink jet head 29 includes an ink jet head for a treatment liquid 29a that ejects a treatment liquid and an ink jet head for ink 29b that ejects an ink composition, and can perform recording on a recording medium M by ejecting the treatment liquid and the ink composition from the nozzles of each ink jet head and attaching the treatment liquid and the ink composition to the recording medium.

In the first embodiment, the ink jet head 29 is a serial type ink jet head, and scans the recording medium M multiple times in the main scanning direction with respect to the recording medium M to attach the ink composition and the treatment liquid (hereinafter, also referred to as “ink and the like”) to the recording medium M. The ink jet head 29 is mounted on the carriage 99 shown in FIG. 2. The ink jet head 29 is scanned multiple times in the main scanning direction with respect to the recording medium M by an operation of the carriage moving mechanism 139 that moves the carriage 99 in a medium width direction of the recording medium M. The medium width direction is the main scanning direction of the ink jet head 29. Scanning in the main scanning direction is also referred to as main scanning.

FIG. 3 shows an arrangement in which the ink jet head for a treatment liquid 29a that ejects the treatment liquid is arranged side by side with the ink jet head for ink 29b that ejects the ink composition at the same position in the transport direction (T2 direction) of the recording medium M. In this case, when the nozzle rows for ejecting the ink included in the ink jet head 29b are projected along the head movement direction (MS), the nozzle rows for ejecting the ink are arranged so that all of the nozzle rows for ejecting the ink overlap the nozzle rows for ejecting the treatment liquid included the ink jet head for a treatment liquid 29a in the nozzle row direction (SS).

With such an arrangement, in the above-described recording method, the treatment liquid attachment step and the ink attachment step described above can be performed by scanning performed while moving the ink jet head for a treatment liquid and the ink jet head for ink with respect to the recording medium, and the treatment liquid and the ink composition are attached to the same scanning region in the same scanning (completely simultaneous strike). The nozzle rows shown in FIG. 3 are a nozzle rows for ejecting the ink and the like in each ink jet head.

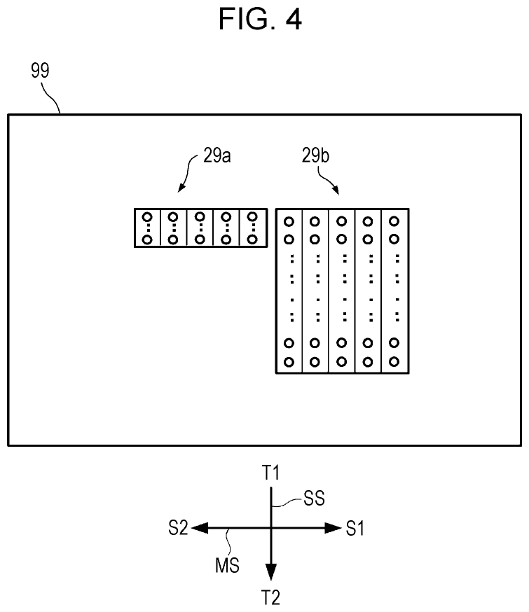

FIG. 4 shows an arrangement in which the ink jet head for a treatment liquid 29a that ejects the treatment liquid is arranged side by side at the same position as the ink jet head for ink 29b that ejects the ink composition in a range of ¼ of the upstream in the transport direction (T2 direction) of the recording medium M. In this case, when the nozzle rows for ejecting the ink included in the ink jet head 29b are projected along the head movement direction (MS), the nozzle rows for ejecting the ink are arranged to overlap the nozzle rows for ejecting the treatment liquid included the ink jet head for a treatment liquid 29a in a range of ¼ of the upstream in the transport direction of the recording medium M in the nozzle row direction (SS).

With such an arrangement, in the above-described recording method, the treatment liquid attachment step and the ink attachment step described above can be performed by scanning performed while moving the ink jet head for a treatment liquid and the ink jet head for ink with respect to the recording medium, and the treatment liquid and the ink composition are attached to the same scanning region in the same scanning (sequential strike). The nozzle rows shown in FIG. 4 are nozzle rows for ejecting ink in each ink jet head.

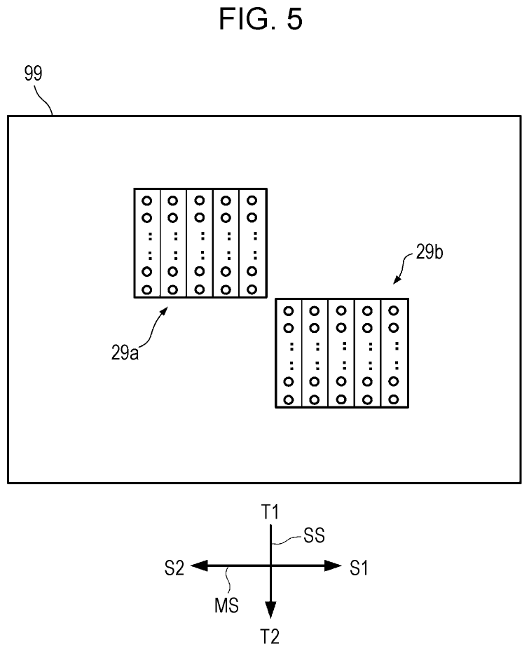

FIG. 5 shows an arrangement not having a portion in which the ink jet head for a treatment liquid 29a that ejects the treatment liquid is arranged side by side with the ink jet head for ink 29b that ejects the ink composition at the same position in the transport direction (T2 direction) of the recording medium M. In this case, when the nozzle rows for ejecting the treatment liquid included in the ink jet head for a treatment liquid 29a are projected along the head movement direction (MS), there is no portion overlapping the nozzle rows for ejecting the ink included in the ink jet head 29b in the nozzle row direction (SS).

With such an arrangement, the treatment liquid attachment step and the ink attachment step can be performed by scanning performed while moving the ink jet head for a treatment liquid and the ink jet head for ink with respect to the recording medium, and the treatment liquid and the ink composition are not attached to the same scanning region in the same scanning. This aspect is not the recording method of the present embodiment.

The main scanning direction is a direction in which the carriage 99 on which the ink jet head 29 is mounted moves. In FIG. 1, the main scanning direction is a direction intersecting a sub-scanning direction, which is a transport direction of the recording medium M indicated by the arrow SS. In FIG. 2, a width direction of the recording medium M, that is, a direction represented by S1↔S2 is a main scanning direction MS, and a direction represented by T1→T2 is a sub-scanning direction SS. In addition, scanning is performed in the main scanning direction, that is, in a direction of either the arrow S1 or the arrow S2 by performing one scanning. Then, the main scanning of the ink jet head 29 and a sub-scanning, which is the transport of the recording medium M, are repeated multiple times to perform recording on the recording medium M. That is, the treatment liquid attachment step and the ink attachment step are performed by a plurality of times of main scanning in which the ink jet head 29 moves in the main scanning direction and a plurality of times of sub-scanning in which the recording medium M moves in the sub-scanning direction intersecting the main scanning direction.

A cartridge 129 that supplies ink and the like to the ink jet head 29 includes a plurality of independent cartridges. The cartridge 129 is detachably attached to the carriage 99 on which the ink jet head 29 is mounted. Each of the plurality of the cartridges 129 is filled with different types of inks and the like, and the ink and the like are supplied to each nozzle from the cartridges 129. In the present embodiment, an example in which the cartridge 129 is mounted on the carriage 99 is shown. However, the present disclosure is not limited thereto. The cartridge 129 may be provided at a location other than the carriage 99 and may be supplied to each nozzle using a supply tube (not shown).

A method known in the related art can be used for the ejection of the ink jet head 29. In the present embodiment, a method for ejecting droplets by using vibration of a piezoelectric element, that is, an ejection method for forming ink droplets by mechanical deformation of an electrostrictive element is used.

The ink jet recording apparatus 19 includes the ventilation fan 89, the IR heater 391, and the platen heater 49 for drying the ink and the like ejected from the ink jet head 29 and attached to the recording medium M. The primary drying step can be performed by appropriately using these ventilation fan 89, the IR heater 391, and the platen heater 49 in combination. In the primary drying step, it is not always necessary to heat the recording medium M, and the ventilation fan 89 may be used alone for carrying out the room temperature air blowing.

When the IR heater 391 is used, the recording medium M can be radially heated by infrared radiation from the ink jet head 29 side. Due to this, the ink jet head 29 is also likely to be heated at the same time, but the temperature can be raised without being affected by a thickness of the recording medium M as compared with the case of being heated from a back surface of the recording medium M such as the platen heater 49. In addition, there are provided various fans (for example, ventilation fan 89), which blow warm air or air having the same temperature as the environment to the recording medium M to dry the ink and the like on the recording medium M.

The platen heater 49 can heat the recording medium M at a position facing the ink jet head 29 through the platen 119 so that the ink and the like ejected by the ink jet head 29 can be dried early from a time when being attached to the recording medium M. The platen heater 49 can heat the recording medium the M in a conductive manner, and the ink or the like can be attached to the recording medium M heated in this manner.

When the IR heater 391 and the platen heater 49 are heated or not heated, the upper limit of the surface temperature of the recording medium M is preferably 45° C. or lower, more preferably 40° C. or lower, even more preferably 35° C. or lower, and still even more preferably 30° C. or lower. Further, the surface temperature is preferably 25° C. or lower. The lower limit is preferably 20° C. or higher, more preferably 30° C. or higher, and even more preferably 35° C. or higher.

In the recording apparatus according to the present embodiment, from the viewpoint of improving the recovery from clogging, it is preferable not to perform drying accompanied by heating in the attachment step, and it is preferable not to have the IR heater 391 or the platen heater 49.

The heating heater 59 is a heater for drying and solidifying the ink and the like attached to the recording medium M, that is, a heater for secondary heating or secondary drying. The heating heater 59 can be used in the secondary drying step. When the heating heater 59 heats the recording medium M on which an image is recorded, the moisture contained in the ink or the like more quickly evaporates and scatters. In this manner, the ink film is firmly fixed or bonded to the recording medium M to have excellent film-forming properties and an excellent high-quality image is obtained in a short time.

An upper limit of the surface temperature of the recording medium M by heating by the heating heater 59 is preferably 120° C. or lower, more preferably 100° C. or lower, and even more preferably 80° C. or lower. In addition, the lower limit of the surface temperature of the recording medium M is preferably 50° C. or higher, more preferably 60° C. or higher, and even more preferably 70° C. or higher. When the temperature is within the above range, a high quality image tends to be obtained in a short time.

The ink jet recording apparatus 19 may include the cooling fan 69. After the ink and the like recorded on the recording medium M is dried, the ink and the like on the recording medium M are cooled by the cooling fan 69, so that an ink coating film can be formed at the recording medium M with good adhesion.

In addition, the ink jet recording apparatus 19 may include the preheater 79 that preheats the recording medium M before the ink and the like are attached to the recording medium M. In addition, the ink jet recording apparatus 19 may include the ventilation fan 89 so that the ink attached to the recording medium M is dried more efficiently.

Below the carriage 99, there are provided the platen 119 that supports the recording medium M, the carriage moving mechanism 139 that moves the carriage 99 with respect to the recording medium M, and the transport unit 149 which is a roller that transports the recording medium M in the sub-scanning direction. The operations of the carriage moving mechanism 139 and the transport unit 149 are controlled by the controller CONT.

### 2.2 Lateral Type Recording Apparatus

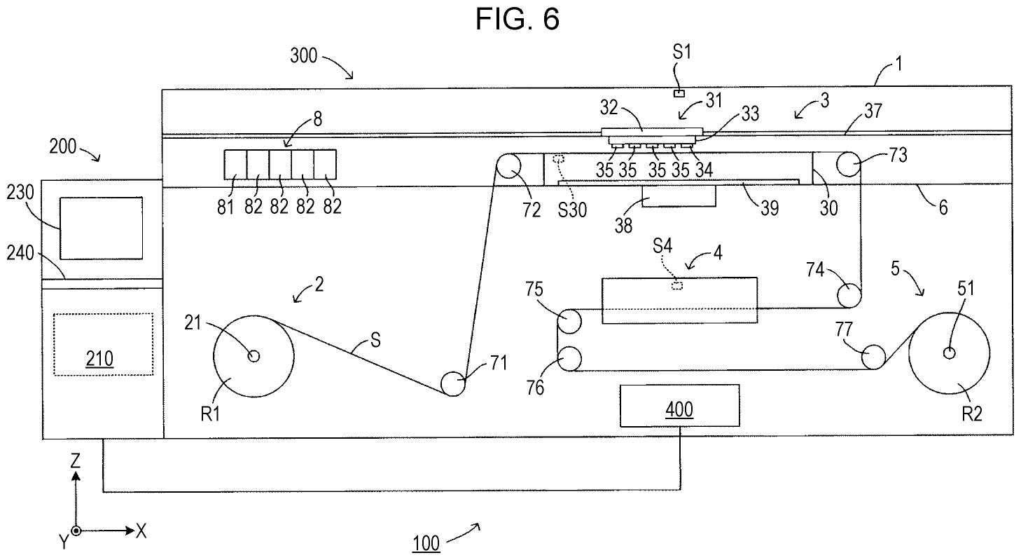

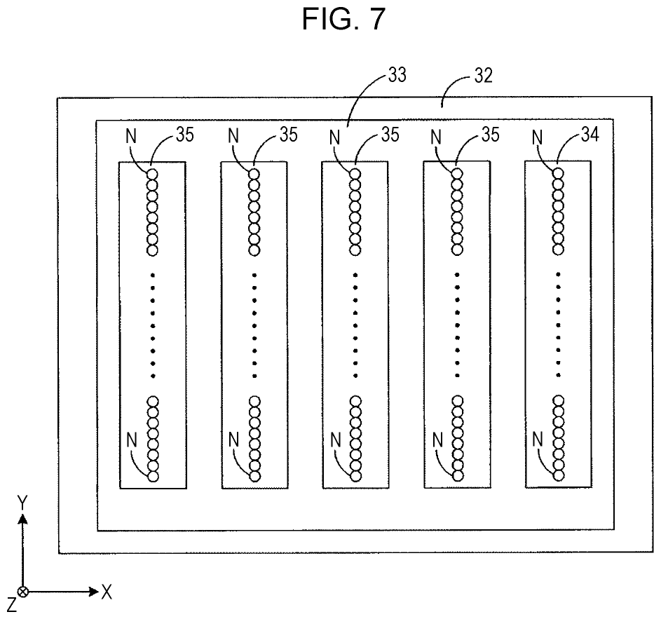

FIG. 6 is a front view schematically showing an example of a lateral type recording apparatus. In FIGS. 6 and 7, XYZ orthogonal coordinates are provided as appropriate for clarity of arrangement relationships of each section of the apparatus, and in the XYZ orthogonal coordinates, a Z-axis is designated as a vertical axis. Further, in the following description, a direction in which each coordinate axis (arrow) orients will be referred to as a positive direction, and a direction opposite to the positive direction will be referred to as a negative direction as appropriate. The form of the recording apparatus shown in FIG. 6 is also particularly referred to as a lateral type recording apparatus since the recording medium is transported in the direction along the axis in the scanning direction.

A recording apparatus 100 includes a host device 200 configured to generate print data from image data (bit map data) received from an external device such as a personal computer, and a printer section 300 configured to print an image based on the print data received from the host device 200. The printer section 300 transports a long sheet S in a roll-to-roll manner, and prints an image on a surface of the sheet S by using an ink jet method.

As shown in FIG. 6, the printer section 300 includes a main body case 1 having a substantially rectangular parallelepiped shape. Inside the main body case 1, a feeding section 2 configured to feed the sheet S from a roll R1 formed by winding the sheet S, a printing chamber 3 configured to eject ink onto the surface of the sheet S fed to perform printing, a drying section 4 configured to dry the sheet S to which the ink is attached, and a winding section 5 configured to wind the sheet S dried as a roll R2 are arranged.

More specifically, the inside of the main body case 1 vertically partitioned in a Z-axis direction by a base 6 having a flat plate shape and arranged parallel (that is, horizontally) to an XY plane, and the upper side of the base 6 is the printing chamber 3. A platen 30 is fixed to an upper surface of the base 6 at a substantially center portion in the printing chamber 3. The platen 30 has a rectangular shape, and supports the sheet S from below by the upper surface parallel to the XY plane. Then, a recording unit 31 performs printing on the surface of the sheet S supported on the platen 30.

On the other hand, the feeding section 2, the drying section 4, and the winding section 5 are arranged on the lower side of the base 6. The feeding section 2 is arranged on the lower side (diagonally left downward in FIG. 6) in the X-axis negative direction with respect to the platen 30, and includes a feeding shaft 21 that is rotatable. The sheet S is wound around the feeding shaft 21 and thus the roll R1 is supported. On the other hand, the winding section 5 is arranged on the lower side (diagonally right downward in FIG. 1) in the X-axis positive direction with respect to the platen 30, and includes a winding shaft 51 that is rotatable. The sheet S is wound around the winding shaft 51 and thus the roll R2 is supported. Further, the drying section 4 is arranged between the feeding section 2 and the winding section 5 in the X-axis direction and immediately below the platen 30.

Then, the sheet S fed from the feeding shaft 21 of the feeding section 2 sequentially passes through the printing chamber 3 and the drying section 4 while being guided by rollers 71 to 77, and then is wound around the winding shaft 51 of the winding section 5. Note that the rollers 72 and 73 are arranged in a straight line (that is, horizontally) in the X-axis direction with the platen 30 interposed between the rollers and, and the top of each of the rollers and is adjusted to be positioned at the same height to the upper surface (surface supporting the sheet S) of the platen 30. Therefore, the sheet S wound on the roller 72 slides onto the upper surface of the platen 30 and moves horizontally (X-axis direction) to the roller 73.

In the printing chamber 3, a printing process is performed on the sheet S by the recording unit 31 arranged on the upper side of the platen 30. The recording unit 31 prints an image on the surface of the sheet S by ejecting the treatment liquid and the ink composition onto the surface of the sheet S. Here, an end portion (left end portion in FIG. 6) in the X-axis negative direction inside the printing chamber 3 is provided with a cartridge attaching section 8. A treatment liquid cartridge 81 configured to store the treatment liquid and a plurality of ink cartridges 82 configured to respectively store the ink composition are detachably attached to the cartridge attaching section 8. Then, the recording unit 31 can eject the treatment liquid supplied from the treatment liquid cartridge 81 and the ink composition supplied from the ink cartridges 82 onto the surface of the sheet S by the ink jet method, respectively.

FIG. 7 is a bottom view partially showing the configuration of the recording unit. Here, the recording unit 31 will be described in detail with reference to FIGS. 6 and 7. The recording unit 31 has a carriage 32, a support plate 33 having a flat plate shape and attached to a lower surface of the carriage 32, and an ink jet head for a treatment liquid 34 and an ink jet head for ink 35 attached to a lower surface of the support plate 33. On the lower surface of the support plate 33, four ink jet head for inks 35 and one ink jet head for a treatment liquid 34 are arranged side by side at equal pitches in the X-axis direction, and a plurality of nozzles N (nozzle rows) are arranged side by side in parallel to the Y-axis direction in each of the ink jet heads 34 and 35. The ink jet head for a treatment liquid 34 ejects the treatment liquid from the nozzles N, and each of the four ink jet head for inks 35 ejects inks of different colors from each other, that is, ink compositions, from the nozzles N.

The length of the nozzle row in the Y-axis direction of the ink jet head for a treatment liquid 34 and the ink jet head for ink 35 is preferably equal to or longer than the length of the sheet S (recording medium) in the Y-axis direction. When the ink jet head having such a length is used, recording can be performed in one pass, and the recording speed is excellent. However, the ink attachment amount is increased, so that bleeding unevenness easily occurs. On the other hand, according to the recording apparatus according to the present embodiment, since the above-described recording method is used, even when recording is performed in one pass, there is a tendency that the image quality (bleeding unevenness) is excellent.

In FIG. 7, when the nozzle rows for ejecting the treatment liquid included in the ink jet head for a treatment liquid 34 are projected in the head movement direction (X-axis direction), the nozzle rows for ejecting the treatment liquid are arranged so that all of the nozzle rows for ejecting the treatment liquid overlap the nozzle rows for ejecting the ink included in the ink jet head for ink 35 in the nozzle row direction (Y-axis direction).

With such an arrangement, in the above-described recording method, the treatment liquid attachment step and the ink attachment step described above can be performed by scanning performed while moving the ink jet head for a treatment liquid and the ink jet head for ink with respect to the recording medium, and the treatment liquid and the ink composition are attached to the same scanning region in the same scanning (completely simultaneous strike).

The description will be continued returning to FIG. 6. The carriage 32 of the recording unit 31 configured as described above is integrally moved with the support plate 33, the ink jet head for a treatment liquid 34, and the ink jet head for ink 35. That is, an X-axis guide rail 37 extending parallel to the X-axis direction is provided in the printing chamber 3, and when the carriage 32 receives a driving force of an X-axis motor, the carriage moves along the X-axis guide rail 37 in the X-axis direction.

The recording unit 31 ejects the treatment liquid from the ink jet head for a treatment liquid 34 and the ink from the ink jet head for ink 35 while moving (scanning) the carriage 32 in the X-axis direction (main scanning direction) above the platen 30, and attaches the treatment liquid and the ink composition to the same scanning region in the same scanning to print an image on the surface of the sheet S stopped on the upper surface of the platen 30. Therefore, on the surface of the sheet S, a two-dimensional image for one frame, in which the length of the nozzle row in the Y direction is the distance of the scanning in the X-axis direction, is printed. Further, the coloring material of the ink forming the two-dimensional image is aggregated by the action of the treatment liquid and fixed on the surface of the sheet S.

Printing of one frame as described above is repeatedly performed while intermittently moving the sheet S in the X-axis direction. Specifically, a predetermined range over substantially the entire upper surface of the platen 30 serves as a printing region. Then, assuming a distance corresponding to a length in the X-axis direction of the printing region (intermittent transport distance) as a unit, the sheet S is intermittently transported in the X-axis direction, and printing of one frame is performed on the sheet S stopped the upper surface of the platen 30 during the intermittent transport. In other words, when the printing of one frame ends on the sheet S stopped on the platen 30, the sheet S is transported in the X-axis direction by the intermittent transport distance to cause an unprinted surface of the sheet S to be stopped on the platen 30. Subsequently, the printing of one frame is newly performed on the unprinted surface. When the printing is completed, the sheet S is again transported in the X-axis direction by the intermittent transport distance. Then, a series of these operations is repeatedly performed.

The printing of one frame may be performed by performing one scanning. In this case, the number of times of scanning is one. Alternatively, the printing of one frame may be performed by two or more scans. In this case, the recording medium is not transported while two or more scans for the printing of one frame are performed. After one frame is printed, the recording medium is transported.

In order to keep leveling the sheet S stopped on the upper surface of the platen 30 during the intermittent transport, the platen 30 may include a mechanism that sucks the sheet S stopped on the upper surface thereof. Specifically, a large number of suction holes (not shown) are opened on the upper surface of the platen 30, and a suction section 38 is attached to the lower surface of the platen 30. Then, the suction section 38 operates, and negative pressure occurs in the suction holes on the upper surface of the platen 30 to suck the sheet S onto the upper surface of the platen 30. Then, while the sheet S is stopped on the platen 30 for printing, the suction section 38 sucks the sheet S to keep leveling the sheet S. On the other hand, when the printing ends, the suction section 38 stops sucking the sheet S, and thus, the sheet S can be smoothly transported.

The heater 39 may be attached to the lower surface of the platen 30. The heater 39 can heat the platen 30 to a predetermined temperature (for example, 30° C.) as necessary. Therefore, the sheet S can be primary dried by the heat of the platen 30 while being subjected to the printing process by the ink jet head for a treatment liquid 34 and the ink jet head for ink 35.

However, in the recording apparatus according to the present embodiment, the recording medium may be heated by a heating mechanism (for example, a heater 39) for heating the recording medium provided in the member supporting the recording medium or a heating mechanism (not shown) for heating the recording medium from above at a location where the ink composition is attached as on the platen 30. Examples of the heating mechanism for heating the recording medium from above include a blower fan, an IR heater, and the like.

However, even when heating is performed, the surface temperature of the recording medium at the time of ink attachment may be the same as that in the example of the recording apparatus in FIG. 1.

As a result, the surface temperature of the recording medium when the ink is attached easily becomes 35° C. or lower, and further excellent recovery from clogging is obtained.

Accordingly, the sheet S subjected to the printing of one frame is intermittently transported to move from the platen 30 to the drying section 4. The drying section 4 can perform a post-heating step of completely drying the treatment liquid and the ink composition landed on the sheet S by air heated for drying.

In the drying section 4, the surface temperature of the sheet S reached may be set as in the example of the recording apparatus in FIG. 1, and it is preferable to perform heating so that the surface temperature of the sheet S reached is 30.0° C. or higher and 120.0° C. or lower, preferably 40.0° C. or higher and 100.0° C. or lower, more preferably 50.0° C. or higher and 95° C. or lower, and even more preferably 70° C. or higher and 90° C. or lower.

Then, the sheet S subjected to the drying process is intermittently transported to reach the winding section 5 and is wound as the roll R2.

### 3. Examples

Hereinafter, the present disclosure will be described in more detail with reference to examples, but the present disclosure is not limited to these examples. Hereinafter, “%” is based on mass unless otherwise specified.

### 3.1 Preparation of Treatment Liquid and Ink Composition

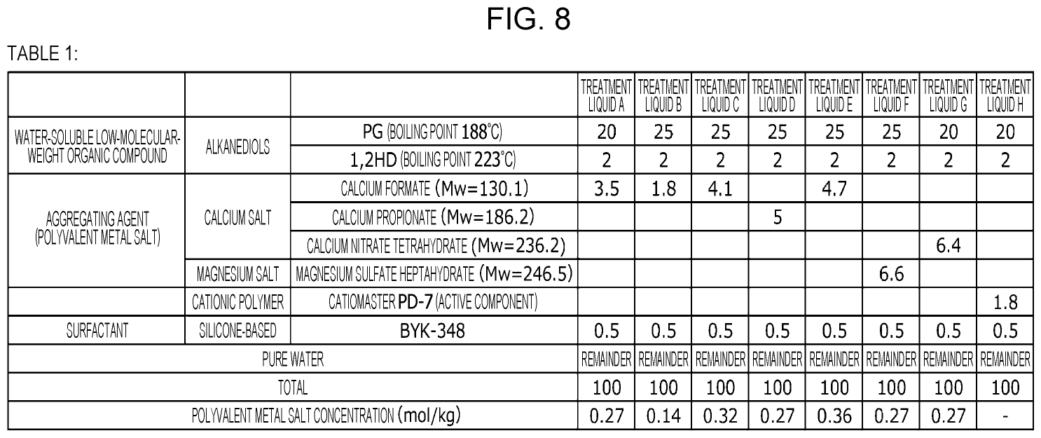

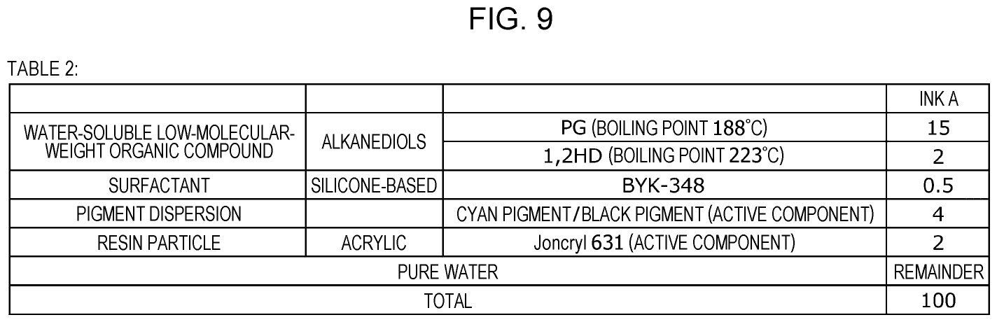

The treatment liquid and the ink composition used in each example or each comparative example were obtained by mixing respective components so that the treatment liquid had the composition of Table 1 (FIG. 8) and the ink composition had the composition of Table 2 (FIG. 9). In Tables 1 and 2, the compositions are shown in terms of % by mass. In addition, the coloring material (pigment) and the resin particles in the tables respectively indicate the solid content (active ingredient). Pure water was added so that the total mass of the treatment liquid or the ink was 100% by mass.

In the ink composition, a water-based pigment dispersion was prepared in advance and used for ink preparation.

In a reaction container equipped with a reflux tube, a gas introduction device, a thermometer, and a stirrer, 198.2 parts of diethylene glycol monobutyl ether, 1.0 part of iodine, 3.7 parts of 2,2′-azobis (4-methoxy-2,4-dimethyl valeronitrile), 66.1 parts of tricyclodecyl methacrylate, and 0.17 parts of diphenylmethane as a catalyst were further charged. The polymerization was performed at 45° C. for 5 hours during flowing of nitrogen, and a solution of an A block polymer was obtained.

Next, the temperature of polymerization was lowered to 40° C., and the solution of the A block polymer obtained above was added with 44.0 parts of tricyclodecyl methacrylate, 17.2 parts of methacrylic acid, and 1.2 parts of 2,2′-azobis(4-methoxy-2,4-dimethylvaleronitrile). Then, the polymerization was performed for 4 hours, then the mixture was heated to 70° C. and polymerized for 1 hour to form a B block polymer, and a solution of an A-B block polymer was obtained.

After cooling the solution of the A-B block polymer obtained above, 66.1 parts of diethylene glycol monobutyl ether were added thereto and dried at 150° C. for 1 hour, and then a polymer having a solid content of 33.0% was obtained.

341 parts of the above-mentioned polymer, 163.6 parts of butyl carbitol, and 450 parts of C.I. Pigment Blue 15:3, which is a cyan pigment, or C.I pigment Black 7, which is a black pigment, were blended and stirred with a disperser. Next, the pigment was sufficiently dispersed by a horizontal media dispersion machine to obtain an oily pigment dispersion. Next, stirring 700 parts of the oily pigment dispersion obtained above with a disperser, a mixture solution made of 4.0 parts of potassium hydroxide and 341 parts of water was gradually added for neutralization, and phase transition was caused. Next, the pigment was sufficiently dispersed by the horizontal media dispersion machine again to obtain an aqueous pigment dispersion.

The description of Tables 1 and 2 (FIGS. 8 and 9) will be supplemented as follows.

### Water-Soluble Low-Molecular-Weight Organic Compound

PG (propylene glycol, normal boiling point: 188° C., property at 25° C.: liquid)
1,2-HD (1,2-hexanediol, normal boiling point: 223° C., property at 25° C.: liquid) Surfactant
BYK-348 (trade name, manufactured by BYK Japan KK., silicone-based surfactant) Aggregating Agent
Catiomaster PD-7 (trade name, manufactured by Yokkaichi Chemical Co., Ltd., amine epichlorohydrin copolymer-based cationic resin)

### Resin Particles

Joncryl 631 (trade name, manufactured by BASF Japan Ltd., styrene-acrylic resin emulsion)

### 3.2 Recording Conditions

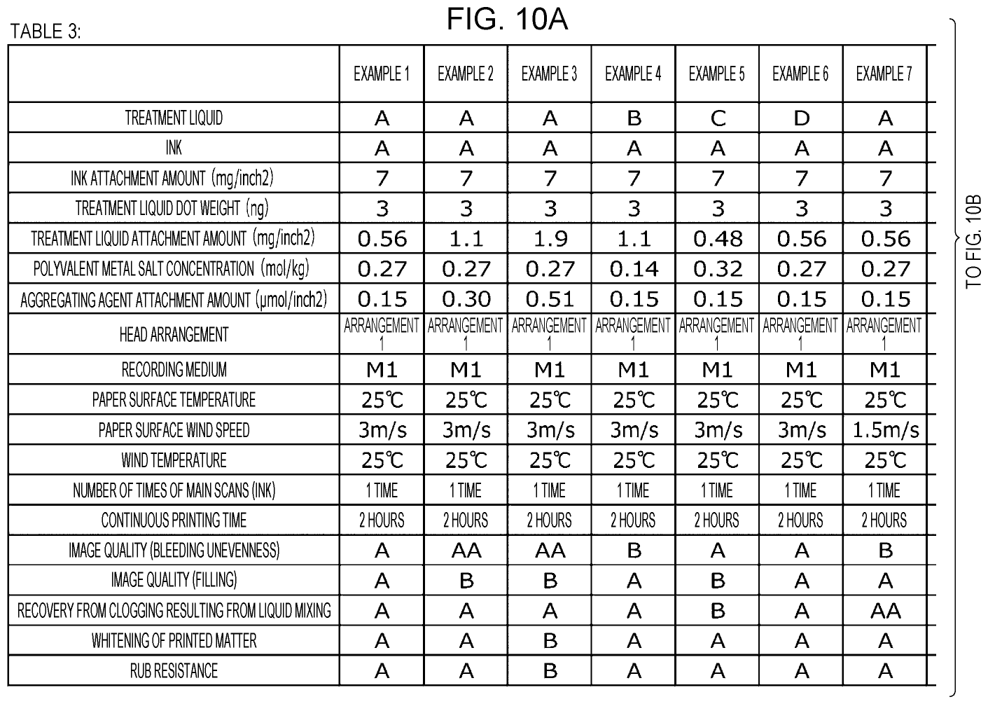

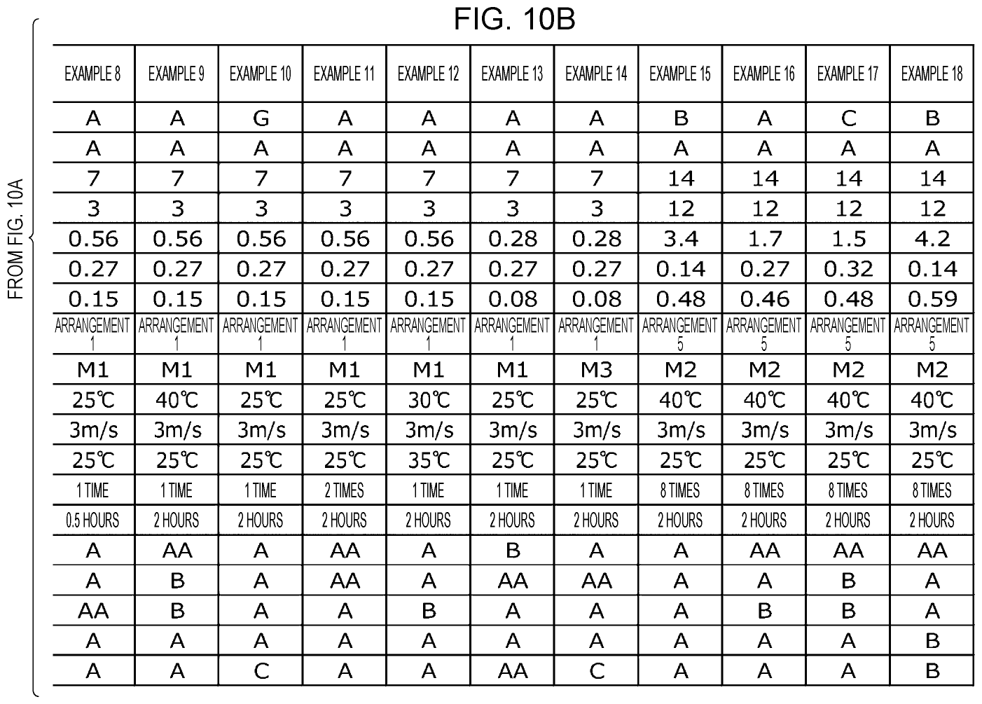

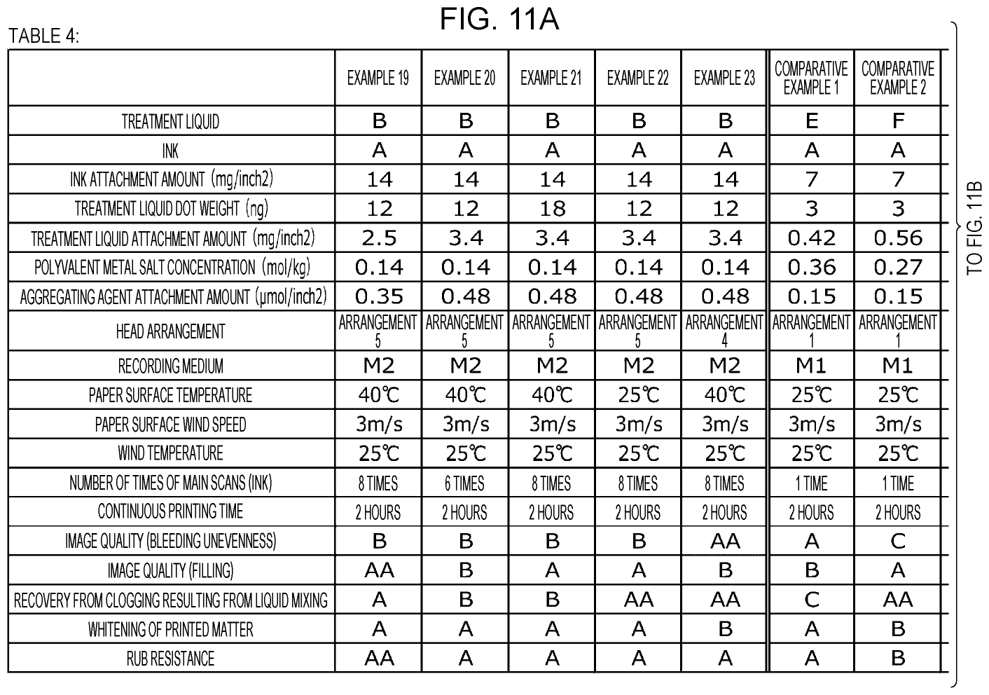

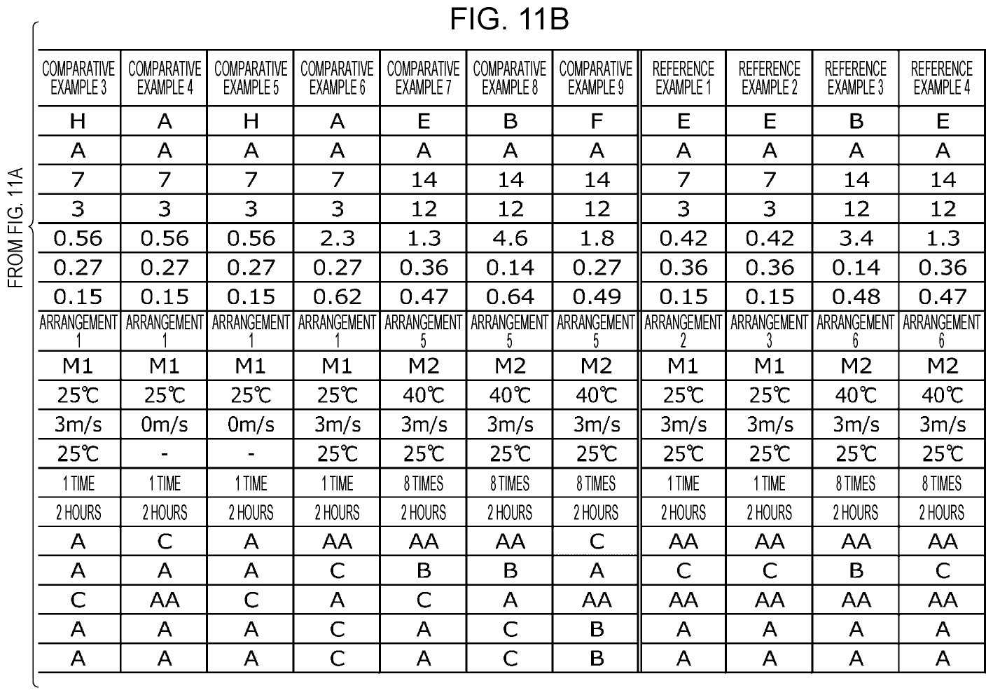

The recording in the evaluation test was performed under the following conditions.
Printer: to be described later
Resolution: 1200×1200 dpi.
Printing pattern: bold pattern (cyan or black)
Number of times of scanning: described in Tables 3 and 4 (FIGS. 10A to 11B)
Paper surface temperature: refer to Tables 3 and 4 (FIGS. 10A to 11B)
Secondary drying temperature: 70° C.
Recording medium: described in Tables 3 and 4 (FIGS. 10A to 11B). Each recording medium type will be described later.
Continuous printing time: refer to Table 3 and Table 4 (FIGS. 10A to 11B). A time period during which recording is continuously performed by performing scanning and transport of the recording medium.

The “paper surface temperature” is the surface temperature of the recording medium at a position facing the ink jet head. In addition, the term “secondary drying temperature” is the surface temperature of the recording medium after the recording medium passes through the platen and the secondary drying step is performed.

In Tables 3 and 4 (FIGS. 10A to 11B), each arrangement in the head arrangement was as follows.

“Arrangement 1”: A modified L-4533AW (manufactured by Seiko Epson Corporation) was prepared as a printer (recording apparatus). The lateral type recording apparatus as shown in FIG. 6 was used. The ink jet head is an ink jet head arrangement shown in FIG. 7, and in the treatment liquid attachment step and the ink attachment step, the treatment liquid and the ink composition are attached to the same scanning region in the same scanning (completely simultaneous strike).

“Arrangement 2”: In Arrangement 1, printing of one frame was performed by performing scanning for attaching only the treatment liquid and then scanning for attaching only the ink. After printing one frame, the recording medium is transported, and the next one frame is printed in the same manner. In the treatment liquid attachment step and the ink attachment step, the treatment liquid and the ink composition are not attached to the same scanning region in the same scanning.

“Arrangement 3”: In Arrangement 1, the recording apparatus was further modified, the ink jet head was fixed at the position near the center of the platen and a line head was obtained. The recording apparatus is a line printer having a line head having a width equal to or greater than the recording width of the recording medium. A recording method in which ink is ejected from the line head toward the recording medium while the position of the recording medium is moved relative to the line head in a scanning direction intersecting the width direction. In the line printer, the head is fixed without moving, and recording is performed in one pass (single pass). During recording, the ink jet head (line head) does not move.

“Arrangement 4”: The ink jet heads were arranged shown in FIG. 4, and in the treatment liquid attachment step and the ink attachment step, the treatment liquid and the ink composition were attached to the same scanning region in the same scanning (sequential strike).

“Arrangement 5”: As the printer (recording apparatus), a modified SC-R5050 (manufactured by Seiko Epson Corporation) was prepared. The serial type recording apparatus as shown in FIG. 1 was used. The ink jet head is an ink jet head arrangement shown in FIG. 3, and in the treatment liquid attachment step and the ink attachment step, the treatment liquid and the ink composition are attached to the same scanning region in the same scanning (completely simultaneous strike).

“Arrangement 6”: In Arrangement 1, the ink jet heads were arranged in an ink jet head arrangement shown in FIG. 5. First, scanning for attaching the treatment liquid is performed on the same scanning region of the recording medium, and then scanning for attaching the ink is performed to perform printing. In the treatment liquid attachment step and the ink attachment step, the treatment liquid and the ink composition are not attached to the same scanning region in the same scanning.

In addition, in Tables 3 and 4 (FIGS. 10A to 11B), “M1” represents PET50A (trade name, manufactured by Lintec Corporation, PET film). “M2” represents Oracal 3165G-010 (trade name, manufactured by ORAFOL Japan Inc., vinyl film). “M3” represents BR9708 (trade name, manufactured by Ahlstrom Germany GmbH, fleece wallpaper, and absorbent recording medium).

### 3.3. Evaluation Test

### 3.3.1 Image Quality (Bleeding Unevenness)

The recording apparatus was filled with the treatment liquid and the ink composition (cyan ink) obtained above, and a cyan solid pattern (the attachment amount is as shown in Tables 3 and 4) was printed on the recording medium. The printed matter was visually evaluated based on the following determination criteria.

### Determination Criteria

AA: Bleeding unevenness cannot be visually recognized at a distance of 20 cm.
A: Bleeding unevenness can be visually recognized at a distance of 20 cm, but cannot be visually recognized at a distance of 50 cm.
B: Bleeding unevenness can be visually recognized at a distance of 50 cm, but cannot be visually recognized at a distance of 80 cm.
C: Bleeding unevenness can be visually recognized at a distance of 50 cm, but cannot be visually recognized at a distance of 80 cm (NG).

### 3.3.2 Image Quality (Filling)

The recording apparatus was filled with the treatment liquid and the ink composition (black ink) obtained above, and 3 pt black characters (the attachment amount is as shown in Tables 3 and 4) were printed on the recording medium. The printed matter was visually evaluated based on the following determination criteria.

### Determination Criteria

AA: White spots cannot be visually recognized at a distance of 20 cm.
A: White spots can be visually recognized at a distance of 20 cm, but cannot be visually recognized at a distance of 50 cm.
B: White spots can be visually recognized at a distance of 50 cm, but cannot be visually recognized at a distance of 80 cm.
C: White spots can be visually recognized even at a distance of 80 cm (NG).
   3.3.3 Recovery from Clogging Resulting from Liquid Mixing

The recording apparatus was filled with the treatment liquid and the ink composition obtained above, and recording was performed under the printing conditions in Tables 3 and 4. At this time, the head voltage was set to 30 V, and the mist generation amount was set to be large. After recording, cleaning was performed three times, and finally, it was determined how many ink nozzles were missing based on the following determination criteria. In addition, in one cleaning, 1 g of ink was discharged from the nozzle row.

### Determination Criteria

AA: All nozzles are restored by only a preliminary ejection operation
A: All nozzles are restored by one cleaning.
B: All nozzles are restored after cleaning is performed three times.
C: There is a non-restored nozzle even after cleaning is performed three times (NG)

### 3.3.4 Whitening of Printed Matter

The recording apparatus was filled with the treatment liquid and the ink composition (black ink) obtained above, a black solid pattern (the attachment amount is shown in Tables 3 and 4) was printed on the recording medium, and the printed matter was visually evaluated based on the following determination criteria.

### Determination Criteria

A: Whitening of the printed matter cannot be visually recognized.
B: Slight whitening of the printed matter occurs, but it is not noticeable.
C: Whitening of the printed matter occurs and is noticeable (NG)

### 3.3.5 Rub Resistance

The recording apparatus was filled with the treatment liquid and the ink composition obtained above, and a solid pattern (the attachment amount is shown in Tables 3 and 4) was printed on the recording medium. After the printed matter was left to stand at room temperature for 30 minutes, the ink attachment portion was cut into a rectangular shape of 25×150 mm, and the degree of peeling of the ink when the cut portion was rubbed with a plain weave fabric moistened with water 100 times using a Gakushin type rub resistance tester (load of 500 g) was visually evaluated based on the following determination criteria.

### Determination Criteria

AA: There is no peeling.
A: There is peeling of less than 20% of the evaluation area.
B: There is peeling of 20% or more and less than 50% of the evaluation area.
C: There is peeling of 50% or more of the evaluation area.

### 3.4 Evaluation Results

The evaluation results are shown in Tables 3 and 4 (FIGS. 10A to 11B).

From the results described in Tables 3 and 4 (FIGS. 10A to 11B), it was found that in each of Examples in which the treatment liquid attachment step of ejecting the treatment liquid containing then aggregating agent from the ink jet head for a treatment liquid and attaching the treatment liquid to the recording medium, and the ink attachment step of ejecting the aqueous ink composition containing the coloring material from the ink jet head for ink and attaching the ink composition to the recording medium were provided, the treatment liquid attachment step and the ink attachment step were performed by scanning performed while moving the ink jet head for a treatment liquid and the ink jet head for ink with respect to the recording medium, the treatment liquid and the ink composition were attached to a same scanning region in the same scanning, the aggregating agent was a calcium salt, the content of the calcium salt with respect to the total mass of the treatment liquid was 0.35 mol/kg or less, in the treatment liquid attachment step, the range of a maximum value of the attachment amount of the calcium salt in the region of the recording medium to which the treatment liquid and the ink composition were attached was 0.6 μmol/inch² or less, and in the treatment liquid attachment step and the ink attachment step, the air blowing step of blowing air onto the recording medium was provided, all of the recovery from nozzle clogging, the image quality (bleeding unevenness suppression), and the whitening reduction of the printed matter were excellent.

On the other hand, in each of Comparative Examples that did not satisfy the above-described configuration, at least one of the recovery from nozzle clogging, the image quality (bleeding unevenness) and the whitening reduction of the printed matter was deteriorated.

In Reference Examples 1, 3, and 4, the treatment liquid was attached before the ink composition was attached, and the treatment liquid and the ink composition were not attached to the same scanning region in the same scanning. In Reference Examples 1 and 4, the recovery from nozzle clogging was not deteriorated even though the content of the calcium salt with respect to the total mass of the treatment liquid exceeded the upper limit. However, since the treatment liquid and the ink composition were not attached to the same scanning region in the same scanning, recording took a long time and this case was not useful.

Further, in Reference Example 2 using a line printer, the recovery from nozzle clogging was not deteriorated even though the content of the calcium salt with respect to the total mass of the treatment liquid exceeded the upper limit. However, during recording, the line head did not move to the position not facing the recording medium and this case was not useful.

The following contents are derived from the above-described embodiments.

A recording method according to an aspect includes
a treatment liquid attachment step of ejecting a treatment liquid containing an aggregating agent from an ink jet head for a treatment liquid and attaching the treatment liquid to a recording medium, and
an ink attachment step of ejecting an aqueous ink composition containing a coloring material from an ink jet head for ink and attaching the ink composition to the recording medium, in which
the treatment liquid attachment step and the ink attachment step are performed by scanning performed while moving the ink jet head for a treatment liquid and the ink jet head for ink with respect to the recording medium,
the treatment liquid and the ink composition are attached to a same scanning region in the same scanning,
the aggregating agent is a calcium salt,
a content of the calcium salt with respect to a total mass of the treatment liquid is 0.35 mol/kg or less,
in the treatment liquid attachment step, a range of a maximum value of an attachment amount of the calcium salt in a region of the recording medium to which the treatment liquid and the ink composition are attached is 0.6 μmol/inch² or less, and
in the treatment liquid attachment step and the ink attachment step, an air blowing step of blowing air onto the recording medium is provided.

In the recording method according to the above aspect,
the air blowing in the air blowing step may have a wind speed of 1.5 m/s or higher.

In the recording method according to the above aspect,
recording according to the recording method may be continuously performed for one hour or longer.

In the recording method according to the above aspect,
the number of times of the scanning in which the ink composition is attached to the same scanning region may be 10 or less.

In the recording method according to the above aspect,
in the treatment liquid attachment step and the ink attachment step, a surface temperature of the recording medium which is to which the attachment is applied may be 35° C. or lower.

In the recording method according to the above aspect,
a wind temperature of the air blowing in the air blowing step may be 35° C. or lower.

In the recording method according to the above aspect,
the calcium salt may be a calcium salt of an organic acid.

According to another aspect of the present disclosure,
there is provided a recording apparatus that performs recording on the recording medium by the recording method according to any one of the above aspects, the apparatus including
the treatment liquid,
the ink composition,
the ink jet head for a treatment liquid, and
the ink jet head for ink.

The present disclosure is not limited to the above-mentioned embodiments, and various modifications can be made. For example, the present disclosure includes a configuration substantially the same as the configuration described in the embodiment, for example, a configuration having the same function, method, and effect, or a configuration having the same object and effect. Further, the present disclosure includes configurations in which non-essential parts of the configuration described in the embodiments are replaced. In addition, the present disclosure includes configurations that achieve the same operational effects or configurations that can achieve the same objects as those of the configurations described in the embodiments. Further, the present disclosure includes configurations in which a known technology is added to the configurations described in the embodiments.

What is claimed is:

1. A recording method comprising:
a treatment liquid attachment step of ejecting a treatment liquid containing an aggregating agent from an ink jet head for a treatment liquid and attaching the treatment liquid to a recording medium; and
an ink attachment step of ejecting an aqueous ink composition containing a coloring material from an ink jet head for ink and attaching the ink composition to the recording medium, wherein
the treatment liquid attachment step and the ink attachment step are performed by scanning which is performed while moving the ink jet head for a treatment liquid and the ink jet head for ink with respect to the recording medium,
the treatment liquid and the ink composition are attached to a same scanning region in the same scanning,
the aggregating agent is a calcium salt,
a content of the calcium salt with respect to a total mass of the treatment liquid is 0.35 mol/kg or less,
in the treatment liquid attachment step, a range of a maximum value of an attachment amount of the calcium salt in a region of the recording medium to which the treatment liquid and the ink composition are attached is 0.6 μmol/inch² or less, and
in the treatment liquid attachment step and the ink attachment step, an air blowing step of blowing air onto the recording medium is provided.

2. The recording method according to claim 1, wherein
the air blowing in the air blowing step has a wind speed of 1.5 m/s or higher.

3. The recording method according to claim 1, wherein
recording according to the recording method is continuously performed for one hour or longer.

4. The recording method according to claim 1, wherein
the number of times of the scanning in which the ink composition is attached to the same scanning region is 10 or less.

5. The recording method according to claim 1, wherein
in the treatment liquid attachment step and the ink attachment step, a surface temperature of the recording medium to which the attachment is applied is 35° C. or lower.

6. The recording method according to claim 1, wherein
a wind temperature of the air blowing in the air blowing step is 35° C. or lower.

7. The recording method according to claim 1, wherein
the calcium salt is a calcium salt of an organic acid.

8. A recording apparatus that performs recording on the recording medium by the recording method according to claim 1, the apparatus comprising:
the treatment liquid;
the ink composition;
the ink jet head for a treatment liquid; and
the ink jet head for ink.
